(19) United States
(12) Patent Application Publication
(10) Pub. No.: US 2001/0014899 A1
(43) Pub. Date: Aug. 16, 2001

(54) Structural documentation system

(76) Inventor: Yasuyuki Fujikawa, Kawasaki (JP)

Correspondence Address: STAAS & HALSEY, Suite 500, 700 Eleventh Street, N.W., Washington, DC, 20001, US

(21) Appl. No.: 09/753,514

(22) Filed: Jan. 4, 2001

(30) Foreign Application Priority Data
Feb. 4, 2000 (JP) 2000-027460

(51) Int. Cl. G06F 15/00

(52) U.S. Cl. 707/513

(57) ABSTRACT

A DTD and pattern tree creating module expresses in a tree form a hierarchical structure of respective elements defined by DTD and pattern information, and adds a description pattern specified with respect to the element concerned to each node in the tree. An entire control module requests a pattern retrieving module to retrieve based on the specified description pattern for every node in this tree. The pattern retrieving module extracts a region coincident with the specified description pattern out of a processing target document, and sends the region back to the entire control module. The entire control module adds tags corresponding to the element in front and rear of the region of a text that has been sent back as what corresponds to the element, thereby outputting a structured document.

### BACKGROUND OF THE INVENTION

1. Field of the Invention

The present invention relates to a structural documentation system for automatically converting an electronic document such as a text, a source program list etc, into a structured document.

2. Description of the Related Art

The structured document is an electronic document such as a general document described in a text format, a source program list etc, which is added with tags serving to indicate meanings of respective regions within that electronic document. The meaning of the respective regions indicated by the tags is, for example, that a content of the region is a header of the electronic document, that a content of the region is a date when the electronic document is created, that a content of the region is a name of a creator who creates the electronic document, that a content of the region is to be displayed with enlarged on browsing software, and so on. A format of the structured document may be exemplified such as XML (Extensible Markup Language), SGML (Standard Generalized Markup Language) and HTML (Hypertext Markup Language), which are different from each other depending on rules for adding the tags. XML and SGML among these languages may be categorized as what a user is able to arbitrarily set a type of the tag, and XML permits user degree of freedom in terms of setting of tags higher than SGML. In this type of structured document, a construction (in which, for example, a header is followed next by a body and consists of a title, a name of a creator and a date of creation) of the electronic document defined by a correlation between the regions with the tags added thereto, is known as DTD (Document Type Definition).

FIG. 33 shows one example of an XML-based structured document. FIG. 34 is a diagram showing DTD of the XML document in a tree structure. As is comprehended by comparing FIGS. 33 and 34 with each other, according to DTD, a plurality of elements (which are regions having meanings) constituting a structured document take a hierarchical structure as a whole, and each element is given a element name (such as “report”, “header”, “title”, . . . ). Namely, the element “report” in the highest-order hierarchy represents the document as a whole, and consists of an element “header” and a plurality of elements “contents”. Further, the element “header” includes an element “title”, an element “date”, an element “person in charge” and an element “name of customer”. Then, tags corresponding to the element names of the respective elements are, as shown in FIG. 34, given to in front and rear of each element in the text of the structured document. For instance, a region of the element “date” is delimited by tags <DATE>˜<DATE> corresponding to this element name “date”. Accordingly, a system designed to deal with the XML or SGML document (which will hereinafter be called an “XML/SGML system”) recognizes that an element “1998.02.17” delimited by these tags indicates a date.

This type of structured document is, unlike a binary file, basically a text file and has therefore such an advantage that it does not depend on the application. Such being the case, the structured document gains a wide spread of its use, by way of its document format for exchanging the information via the Internet etc. and for managing the information in a database, in the background where the Internet has been expanding over the recent years. Hence, there exists a demand for converting a numerous amount of electronic documents which are not structured document and which were created before that type of structured document prevails into structured documents and for dealing with the converted structured documents together with those originally created as the structured documents thereafter. According to the prior art, the operator must examine contents of the electronic documents on an editor screen and add tags suited to the contents in meaning through a manual input while referring to DTD in order to convert the existing electronic document into the structured document.

On the other hand, with respect to a program source given by way of other example of the electronic document, there has hitherto existed a tool for extracting a necessary piece of information by analyzing both of a comment and a syntax element based on BNF (Backus-naur Form). The conventional tool is, however, fixed in terms of extractable contents and an output format as well and does not exhibit a flexibility.

### SUMMARY OF THE INVENTION

It is a primary object of the present invention, which was devised under such circumstances, to provide a structural documentation system capable of automatically generating a structured document on the basis of a processing target electronic document described in a text format.

To accomplish the above object, according to one aspect of the present invention, a structural documentation system comprises a reading module which reads definition information defining a correlation between elements as basic units configuring a predetermined document structure, and defining, for each of the elements, an extraction condition and an identifier thereof, a retrieving module which refers to the extraction condition per element that is defined by the definition information read by the reading module, and which extracts a region coincident with the per-element extraction condition referred to out of the processing target electronic document, and a structured document generating module which combines the regions extracted with respect to the respective elements by the retrieving module in accordance with the correlation between the elements that is defined by the definition information, and which generates the structured document by adding to each region an identifier defined by the definition information.

In the structural documentation system having the above architecture according to the present invention, the definition information read by the reading module defines the correlation between the elements configuring the document structure of the structured document to be obtained as a result of the conversion, the identifier given to each element and the extraction condition for extracting the region corresponding to each element out of the processing target electronic document. Accordingly, the retrieving module is capable of extracting the region coincident with the extraction condition of each element out of the processing target electronic document by referring to the extraction condition for every element. As a result, the structured document generating module combines the regions extracted by the retrieving module in accordance with the correlation between the elements that is defined by the definition information, and is capable of generating the structured document by adding to each region the identifier defined by the definition information with respect to the element corresponding to the region concerned.

According to the present invention, a requirement for the electronic document treated as the processing target is merely that this document is described in a text format, and therefore the electronic document includes a source program list such as Java source etc. as well as a general document. Note that a comment categorized as a general text may also be contained in the source program list. According to the present invention, the structured document obtained as a result of the conversion, more specifically, a type of the identifier defined by the definition information may be based on the XML format or the SGML format. When based on these formats, the identifier is tags added in front and rear of each region.

### BRIEF DESCRIPTION OF THE DRAWINGS

FIG. 1 is a conceptual view showing a concept of a structural documentation system in an embodiment of the present invention together with concepts of a DTD (Document Type Definition) and pattern edit system and of a DTD and pattern creation support system;

FIG. 2 is a block diagram showing an architecture of a computer in which the structural documentation system etc is actualized;

FIG. 3 is a program architecture diagram showing a detailed module architecture of the structural documentation system;

FIG. 4 is a flowchart showing a processing by the structural documentation system;

FIG. 5 is a flowchart showing an output-result-tree creation subroutine executed in S007 in FIG. 4;

FIG. 6 is a flowchart showing the output-result-tree creation subroutine executed in S007 in FIG. 4;

FIG. 7 is a diagram showing an example of a structure of a DTD and pattern tree;

FIG. 8 is a diagram showing an example of a text of a processing target document;

FIG. 9 is a diagram showing an example of a structure of an output-result-tree;

FIG. 10 is a diagram showing an example of a structured document;

FIG. 11 is a table showing a rule of a regular expression;

FIG. 12 is a diagram showing an example of a structure of the DTD and pattern tree;

FIG. 13 is a diagram showing an example of a text of the processing target document;

FIG. 14 is a table showing a part of BNF definitions;

FIG. 15 is a diagram showing a range of syntax element;

FIG. 16 is a diagram showing an example of a structure of a syntax/comment tree;

FIG. 17 is a diagram showing an example of a structure of the output-result-tree;

FIG. 18 is a diagram showing an example of an edit screen by a DTD and pattern edit system;

FIG. 19 is a diagram showing an example of a text of DTD and pattern information;

FIG. 20 is a diagram showing an example of a structure of a DTD and pattern tree;

FIG. 21 is a diagram of an example of a text of the processing target document;

FIG. 22 is a diagram showing an example of a structure of the output-result-tree;

FIG. 23 is a diagram showing an example of a structured document;

FIG. 24 is a diagram showing an example of a selection screen by the DTD and pattern creation support system;

FIG. 25 is a diagram of a text of typical pattern definition information;

FIG. 26 is a diagram of the text of the typical pattern definition information;

FIG. 27 is a flowchart showing a processing procedure by the DTD and pattern creation support system;

FIG. 28 is a diagram showing an example of a selection screen shown by the DTD and pattern creation support system;

FIG. 29 is a diagram showing an example of a description pattern created by the DTD and pattern creation support system;

FIG. 30 is a diagram showing an example of the selection screen shown by the DTD and pattern creation support system;

FIG. 31 is a diagram showing an example of the selection screen shown by the DTD and pattern creation support system;

FIG. 32 is a diagram showing an example of the selection screen shown by the DTD and pattern creation support system;

FIG. 33 is a diagram showing an example of a text of a conventional structured document; and

FIG. 34 is a diagram showing an example of a tree structure of the conventional structured document.

### DESCRIPTION OF THE PREFERRED EMBODIMENT

An embodiment of the present invention will hereinafter be described with reference to the accompanying drawings.

### FIRST EMBODIMENT

(Outline of Embodiment)

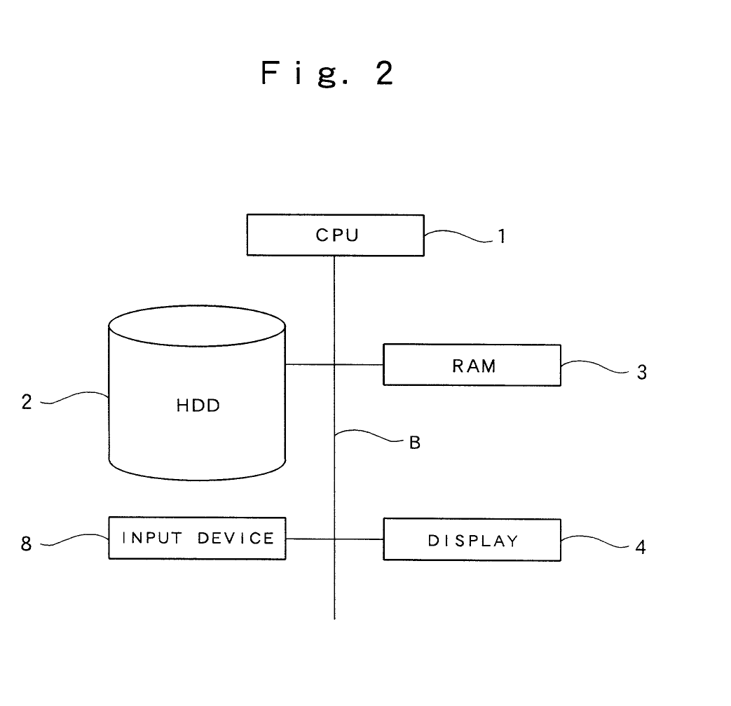

A structural documentation system according to the present invention is actualized in a computer system typically constructed of a CPU 1, a hard disk 2, a RAM 3, a display 4 and an input device 8, which are connected to each other via a bus B. To be more specific, the structural documentation system is actualized in such a way that the CPU 1 reads a program stored in the hard disk 2 onto the RAM 3, processes based on the program are sequentially executed according to operator's operations inputted via the input device (a keyboard and mouse) 8, and results of these processes are displayed on the display 4. Namely, the hard disk 2 corresponds to a computer readable medium according to the present invention. The CPU 1 and the RAM 3 correspond to a reading unit, searching unit, a structured document creating unit and a computer. Note that all the hardware components configuring a structural documentation system are exemplified as those of a local computer in FIG. 2, however, the present structural documentation system may be actualized as a distributed processing system configured by connecting a plurality of computers via a network such as LAN, the Internet etc.

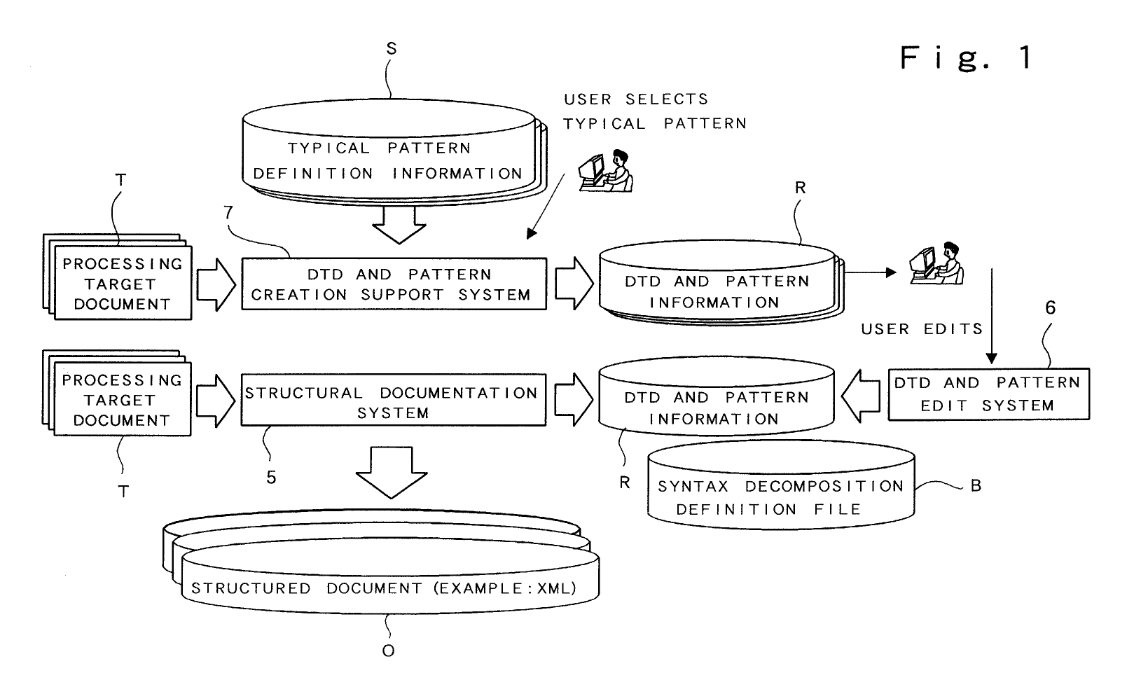

Next, an outline of the structural documentation system actualized in the way described above will be explained. FIG. 1 is a conceptual view showing a concept of a structural documentation system 5 in the first embodiment together with concepts of a DTD (Document Type Definition) and pattern edit system 6 and of a DTD and pattern creation support system 7 that are defined as extended functions thereof. As shown in FIG. 1, in the structural documentation system 5, a general document described in a text format and a source program list described in accordance with a BNF (Backus-naur Form)-based syntax, are processing target documents (texts) T. Further, this structural documentation system 5 is previously registered with “DTD and pattern information (definition information)” R which defines a correlation between elements constituting a structure of the structured document that is to be finally created (which may be called DTD), and, for every element, a description pattern (extraction conditions) respectively serving as a key for automatically extracting region corresponding to each element in the DTD out of the processing target document T and a tag (i.e., a name of element as an identifier) added to the region. Then, the structural documentation system 5 extracts, from the processing target document T, a region coincident with an extraction condition for each element defined by the DTD and pattern information R, and combines the thus extracted regions on the basis of the correlation between the elements defined by the DTD and pattern information R. Subsequently, the structured documentation system 5 puts the tags defined by the DTD and pattern information R at the front and rear of each region. Thus, the structural documentation system 5 eventually creates and outputs a “structured document” O consisting of a plurality of regions respectively attached with tags. This “structured document” O has the structure based on XML (Extensible Markup Language) or SGML (Standard Generalized Markup Language), and can be therefore processed by a typical XML/SGML system.

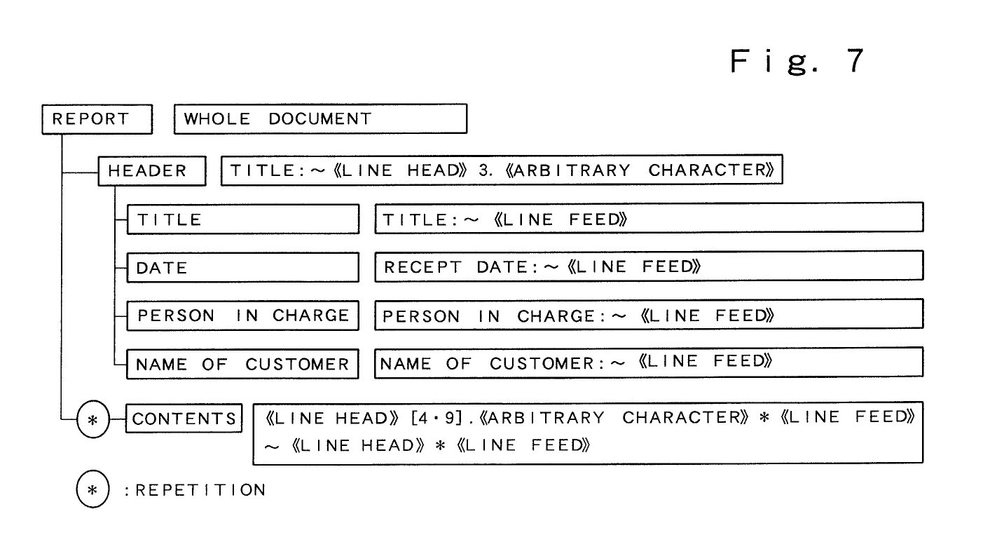

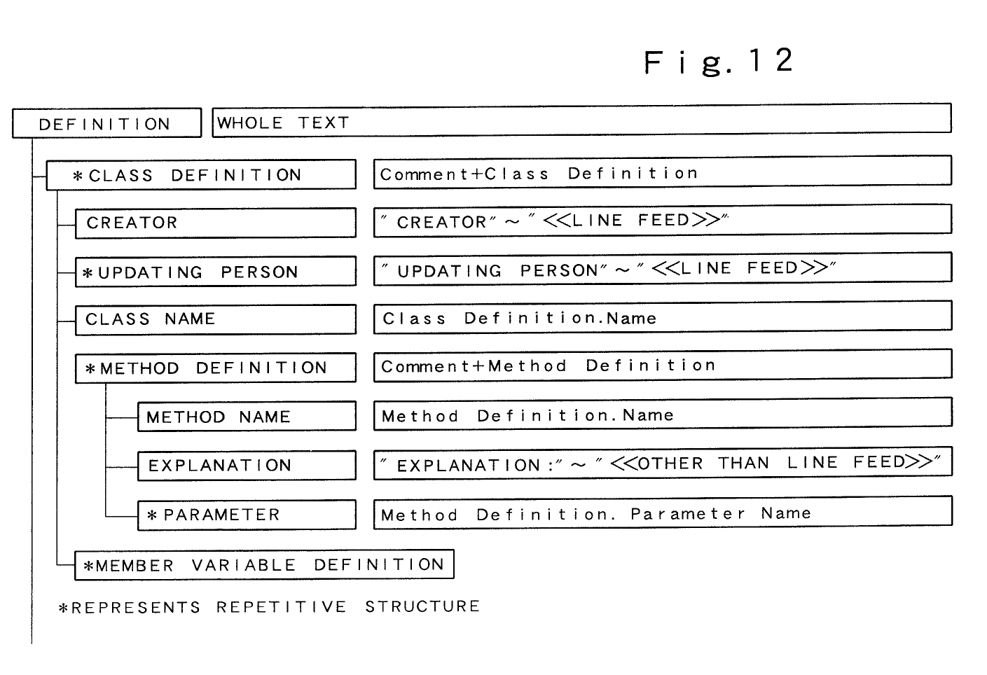

The DTD and pattern information R itself is defined as a file expressed in the text format. As shown in FIGS. 7 and 12, however, as based on the general DTD given above, hierarchical structures (i.e., the hierarchical structures configured such that the elements of one higher-order hierarchy embrace the elements of a plurality of lower-order hierarchies) of the respective elements can be expressed in a tree structure. When thus expressed in the tree structure, the element, which represents the whole document and ranks at the highest-order hierarchy, is known as a “root node”. Further, the elements existing in the hierarchies just under the target element are referred to as “member (child) nodes” to the target element. Reversely, the element existing in the hierarchy just above the target element is called a “owner (parent) node” to the target element. Further, a “child node” of the “child node” is termed a “grandchild node”. Moreover, among the “child nodes” under the same “parent node”, the nodes existing higher in the tree structure are termed “elder brother nodes” to the nodes existing lower, while the nodes existing lower are called “younger brother nodes” to the nodes existing higher. Especially, the node existing highest among the “child nodes” belonging to the same “parent node” is referred to as an “oldest child node” to the “parent node”. Note that if the elements each having the same element name (viz., the elements having the same structure) are repeated, that element name is marked with “*”, which indicates a meaning of “repetition (repetitive structure)”.

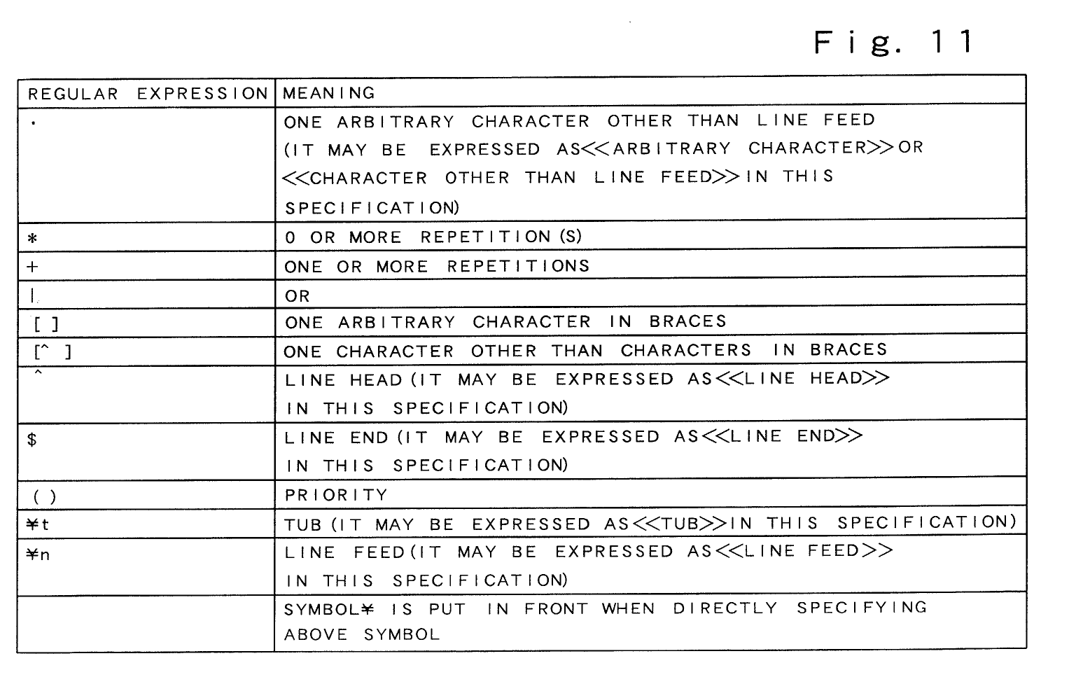

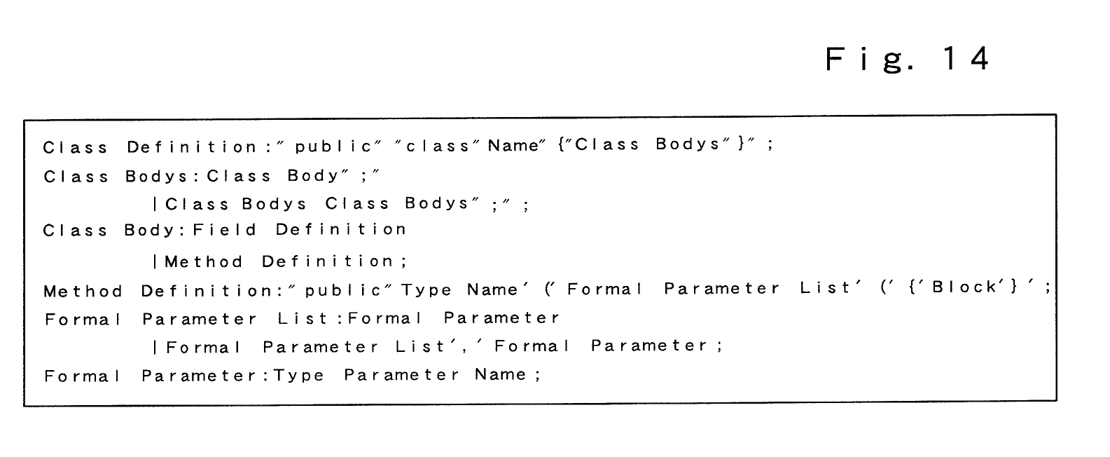

This DTD and pattern information R is, however, different from the general DTD in terms of such a point that it defines, for every elements, a description pattern indicating an extraction condition for extracting region corresponding to the element. Usable modes of specifying the extraction condition by this description pattern may be a mode of specifying a start pattern and an end pattern of the region that should be extracted with a character string itself or with a regular expression, and a mode of the whole region that should be extracted with the regular expression. FIG. 11 shows a part of the rule of the regular expression. In the former case, it may be specified whether or not the start or end pattern thereof is contained in the region that should be region, whether or not a region extending from a portion immediately after the start pattern is set as a region that should be extracted, or whether or not a region extending to a portion just before the end pattern is set as a region that should be extracted. These variety of specifying modes may be mixed within the same DTD and pattern information R. Note that if the processing target document T is categorized as a source program list described pursuant to the BNF (Backus-naur Form)-based syntax, a mode of specifying by “syntax element” based on BNF is utilized. FIG. 14 shows a part of the rule of the BNF. In this case, it is also feasible to specify that comments existing anterior or posterior to the “syntax element” be extracted together. Further, there is adopted a mode of specifying the description pattern with the above-described character string itself or with the regular expression with respect to the child nodes as for this comment segment. In any case, the extracting condition of the element representing the whole processing target document T is specified such as “whole document” in a special case. Information within the DTD and pattern information R for specifying the description pattern as described above in many ways, will hereinafter be called description pattern information.

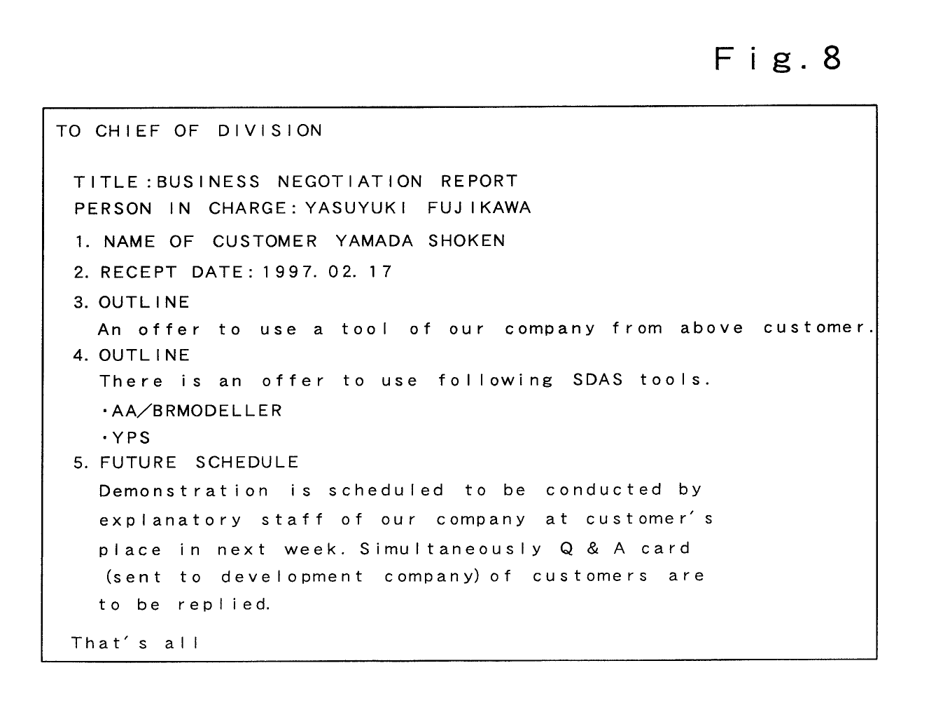

FIG. 7 is a diagram showing, in the tree structure, an example of the DTD and pattern information R applied to the case where the typical document as shown in FIG. 8 is defined as the processing target document T. In the sample shown in FIG. 7, a description pattern information for extracting an element “header” shows that its extraction target region extends from a portion just after a region corresponding to the description pattern consisting of a character string “title” to a portion just before a region corresponding to a description pattern in which a character string “3” exists after 0 or more space(s) from line head, and arbitrary character is subsequent to “3”. Furthermore, a description pattern information for extracting an element “date” defined as the child node to the element “header” shows that its extraction target region extends from a portion just after a region corresponding to a description pattern consisting of a character string “corresponding date:” to a portion just before a first line feed thereafter, within the regions extracted with the description pattern of the element “header”. Moreover, a description pattern information for extracting an element “content” marked with “*” indicating “repetition” shows that its extraction target region extends from a portion just after a region corresponding to a description pattern where a character string consisting of any numeral of “4” through “9” and “.” follows 0 or more space(s) after line head and thereafter arbitrary character(s) repeats until a line feed to a portion just before a region corresponding to a description pattern where line feed is immediately after line head.

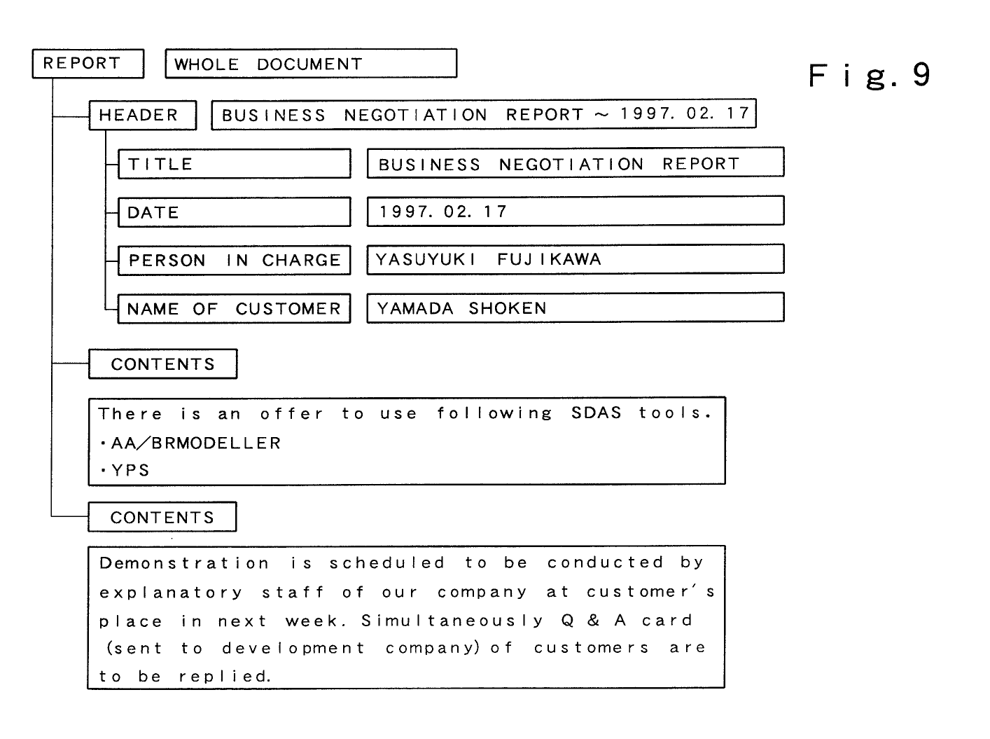

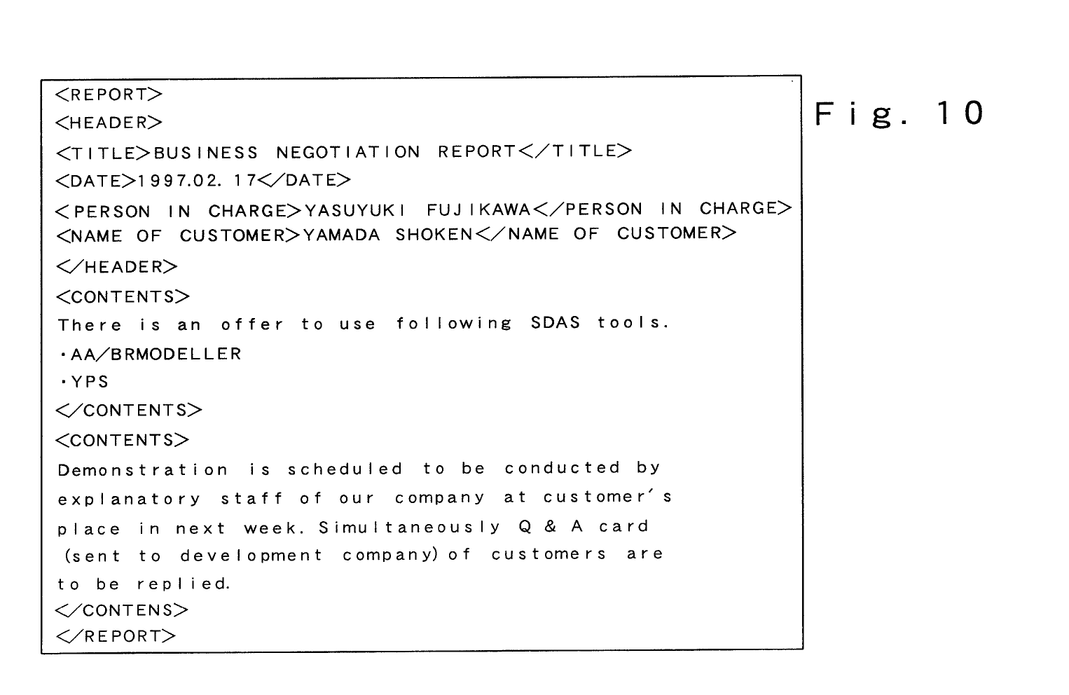

FIG. 9 illustrates a tree structure in which regions which are extracted form the processing target document T shown in FIG. 8 on the basis of the DTD and pattern information R shown in FIG. 7 are hierarchized based on the correlation defined by the DTD and pattern information R. In this tree structure, the region extracted as the element “header” is “Business negotiation report˜1997.02.17”, and the region extracted as the element “date” is “1997.02.17”. The regions extracted as the element “content” are two regions, i.e. “There is˜YPS” and “Demonstration is˜to be replied”. Further, FIG. 10 shows a structured document O created by putting an element name as tags in front and rear of a region extracted corresponding to each element on the basis of the tree structure shown in FIG. 9.

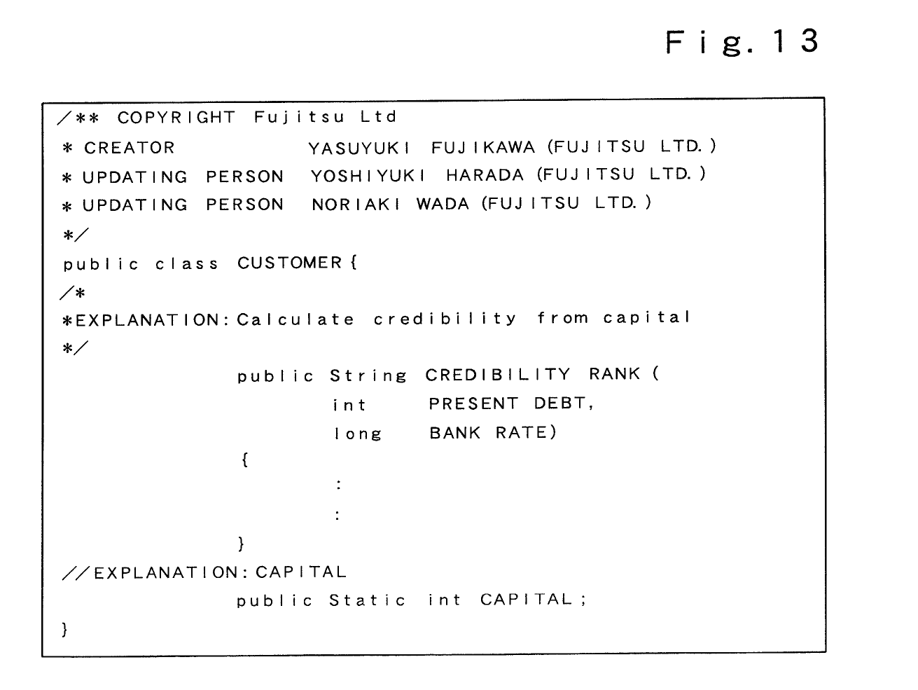

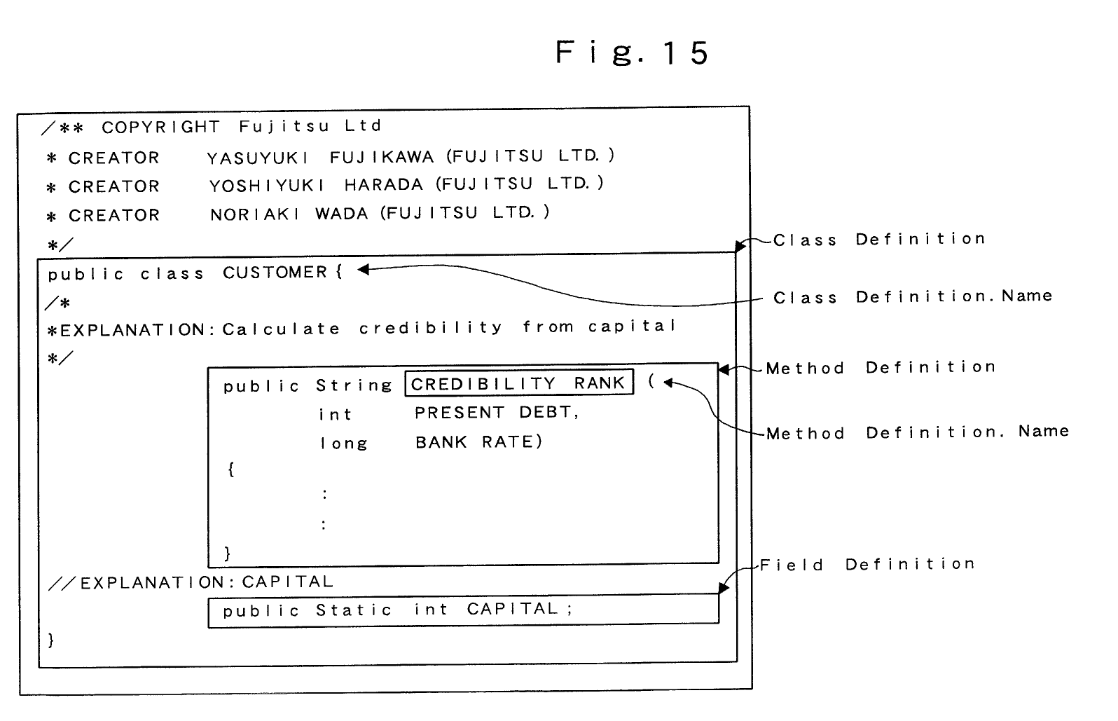

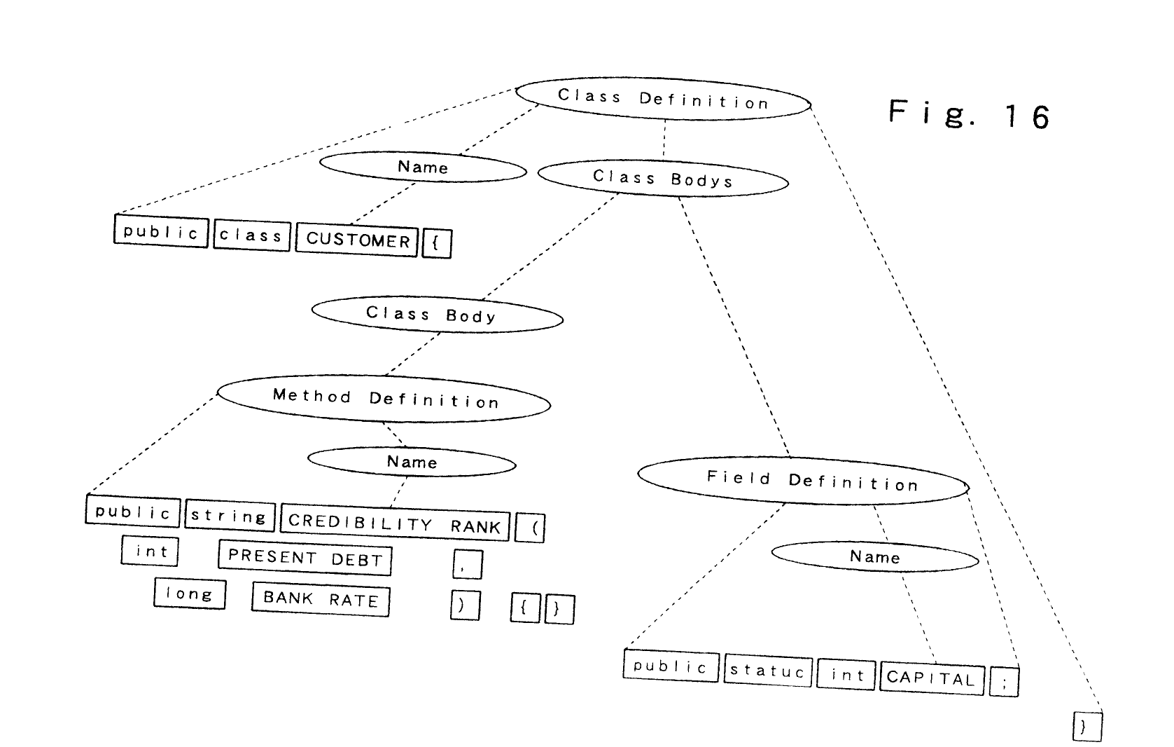

FIG. 12 is a diagram showing, in the tree structure, an example of the DTD and pattern information R applied to a source program list (more specifically, Java source) as shown in FIG. 13 as the processing target document T. Note that if the source program list is the processing target document T, the structured documentation system 5 analyzes, as shown in FIG. 15, a range and a content of each syntax element contained in this processing target document T in accordance with a syntax decomposition definition file B in which BNF (Backus-naur Form) is defined, as partially shown in FIG. 14. Then, a hierarchical structure formed of the syntax elements analyzed is configured as a tree structure (syntax and comment tree) as shown in FIG. 16 on the RAM 3. As obvious from FIGS. 14 through 16, according to BNF, for instance, “Class Definition” contains “Name (“customer” in examples shown in FIGS. 13 and 15)” and “Method Definition” or “Field Definition”. “Method” Definition likewise contains “Name (“credibility rank” in the examples shown in FIGS. 13 and 15)”.

In the DTD and pattern information R shown in FIG. 12, a description pattern information for extracting the element “Class Definition” shows that extraction target regions are a syntax element region coincident with the syntax element “Class Definition” defined in BNF and a comment region of comments continuous just before the syntax element region. Further, a description pattern information for extracting an element “creator” defined as a child node to the element “Class Definition” shows that an extraction target region extends from a portion just after a region corresponding to the description pattern consisting of the character string “creator” to a portion just before a first line feed thereafter, in the comment region extracted with the description pattern of the element “Class Definition”. Moreover, a description pattern information for extracting an element “Class Name” defined as a child node to the element “Class Definition” shows that an extraction target region is a region coincident with the syntax element “Name” defined in BNF, in the syntax element region extracted with the description pattern of the element “Class Definition”. Further, a description pattern information for extracting an element “Method Definition” defined as a child node to the element “Class Definition” shows that extraction target regions are a syntax element region coincident with the syntax element “Method Definition” defined in BNF and a comment region of the comments continuous just before the syntax element region, in the syntax element region extracted with the description pattern of the element “Class Definition”. Furthermore, a description pattern information for extracting an element “Method Name” defined as a child node to the element “Method Definition” shows that an extraction target region is a region coincident with the syntax element “Name” defined in BNF, in the syntax element region extracted with the description pattern of the element “Method Definition”. Moreover, a description pattern information for extracting an element “Explanation” defined as a child node to the element “Class Definition” shows that an extraction target region extends from a portion just after a region corresponding to a description pattern consisting of the character string “Explanation:” to an arbitrary character other than line feed just before the line feed, in the comment region extracted with the description pattern of the element “Method Definition”. Furthermore, a description pattern information for extracting an element “Parameter” given the repetitive structure and defined as a child node to the element “Method Definition” shows that an extraction target regions is whole region coincident with the syntax element “Parameter” defined in BNF, in the syntax element region extracted with the description pattern of the element “Method Definition”.

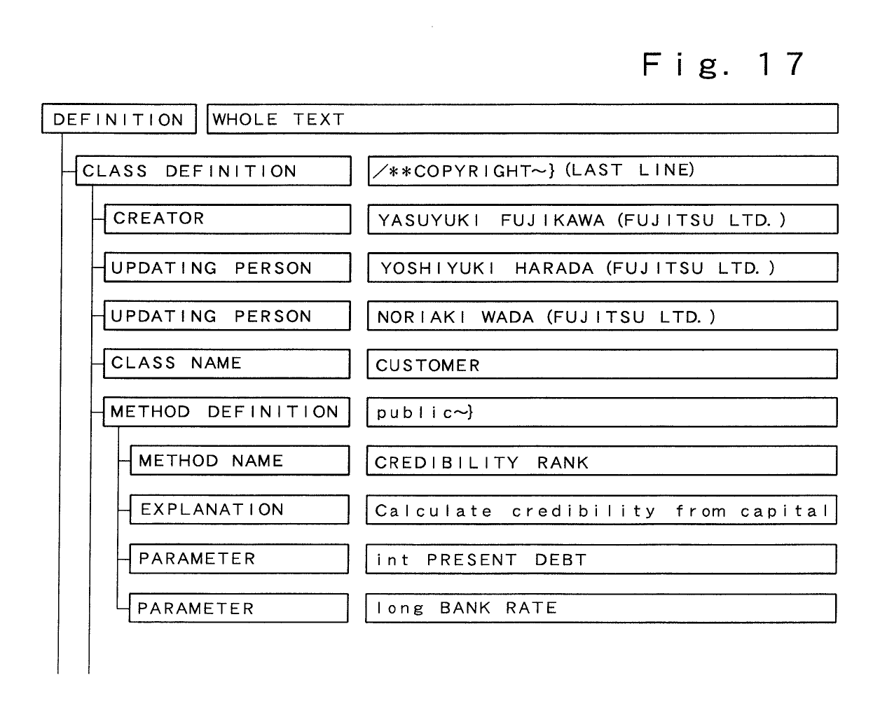

FIG. 17 shows a tree structure in which extracted regions which are extracted from the processing target document T shown in FIG. 13 on basis of the DTD and pattern information R shown in FIG. 12 are hierarchized based on the correlation defined by the DTD and pattern information R. In this tree structure, a region as the element “Class Definition” is:

“/**COPYRIGHT Fujitsu LTD

*Creator Yasuyuki Fujikawa (Fujitsu LTD)

*Updating person Yoshiyuki Harada (Fujitsu LTD)

*Updating person Noriaki Wada (Fujitsu LTD)

*/

public class customer {

*/

*Explanation: Calculate credibility from capital.

*/

public string Credibility Rank (

int Present Debt

long Bank Rate)

{

:

:

}

//Explanation: Capital.

public static int Capital:

}”.

The region extracted as the element “Creator” is “*Creator Yasuyuki Fujikawa (Fujitsu LTD)”, and the region extracted as the element “Class Name” is “Customer”. The region extracted as the element “Method Definition” is:

*/

*Explanation: Calculate credibility from capital.

*/

public string Credibility Rank (

int Present Debt

long Bank Rate)

{

:

:

}”.

The region extracted as the element “Method Name” is “Credibility Rank”, and the region extracted as the element “Explanation” is “Calculate credibility from capital.” The region extracted as the element “Parameter” are two regions, i.e., “int Present Debt” and “long Bank Rate”.

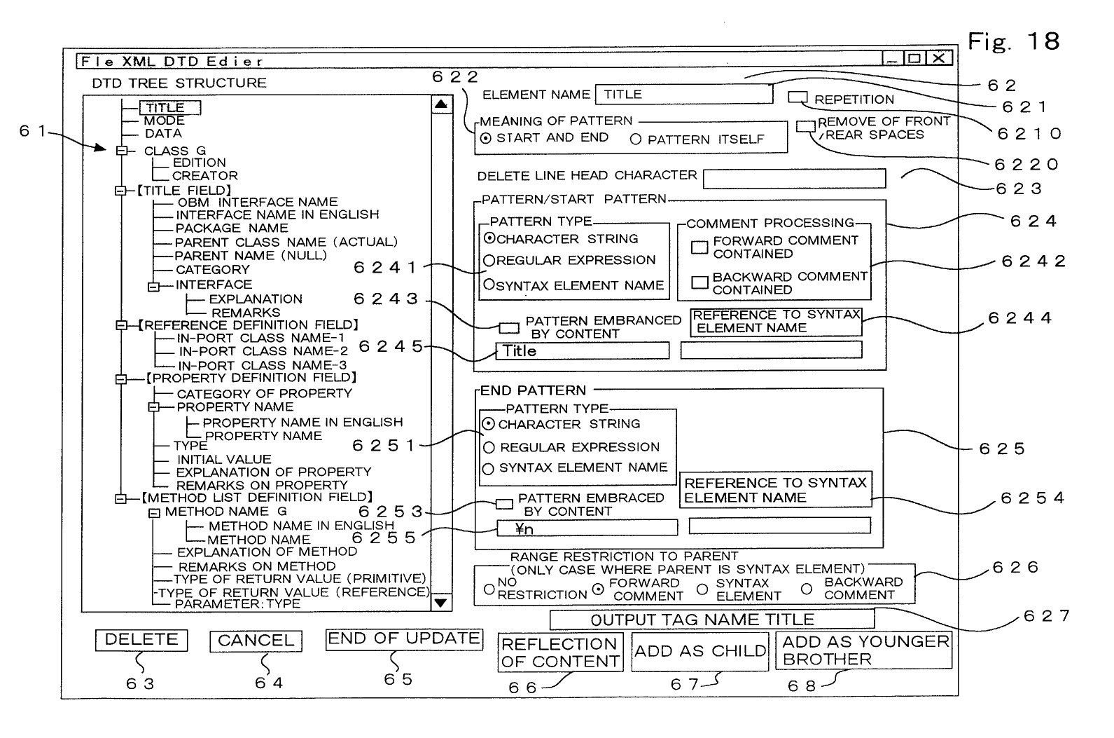

Referring back to FIG. 1, the DTD and pattern information R referred to in the way described above by the structured documentation system 5, is edited by the DTD and pattern edit system 6. This DTD and pattern edit system 6 is classified as a text editor including GUI (Graphical User Interface, i.e., edit screen) as shown in FIG. 18. A left half of the edit screen of the DTD and pattern edit system 6 is a DTD tree structure list box 61, and a right half thereof is an item input area 62. Further, a “delete” button 63, a “cancel” button 64, an “end-of-update” button 65, a “content reflection” button 66, an “add as child” button 67 and an “add as younger brother” button 68, are displayed in line in the vicinity of a lower end of the screen.

The DTD tree structure list box 61 is a list box for displaying names of the elements defined by the DTD and pattern information R on edit by way of a tree structure representing hierarchical structure among the elements. When the operator clicks any one of the element names displayed in the DTD tree structure list box 61 by use of the input device (mouse) 8, the element indicated by the clicked element name is selected as a processing target. Then, a display color thereof is changed (the display color of the element name “Title” has been changed in the example shown in FIG. 18), and the present set contents with respect to the element indicated by this clicked element name are displayed in those text boxes, check boxes and option buttons in the item input area 62.

The item input area 62 includes an “element name” text box 621, a “repetition” check box 6210, a “pattern meaning” option button 622, a “remove of front/rear space” checkbox 6220, a “delete line head character” text box 623, a “pattern/start pattern” specifying field 624, an “end pattern” specifying field 625, a “range restriction to parent” option button 626, and an “output tag name” text box 627.

The “element name” text box 621 is a text box for displaying and for describing the name of the element that is now being selected. Further, the “repetition” check box 6210 is a check box for displaying whether or not the repetition (repetitive structure) is given to the element that is now being selected. The “pattern meaning” option button 622 is an option button for displaying whether the mode of specifying the description pattern in the element that is now being selected is a mode of specifying the start pattern and the end pattern of the element or a mode of specifying the description pattern itself of the whole element. Further, the “remove of front/rear space” check box 6220 is a check box for displaying and for selecting whether space(s) should be removed or not in case space(s) is contained in front or rear of the extraction target region corresponding to the selected element. The “delete line head character text box 623 is a text box for displaying and for specifying a character string to be deleted if contained in the line head of the extraction target region corresponding to the selected element.

The “pattern/start pattern” specifying field 624 is a field for displaying and for setting a content of the description pattern itself of the whole element that is now being selected in case the pattern itself is specified by the “pattern meaning” option button 622 or of the start pattern thereof in case the start and the end are specified by the “pattern meaning” option button 622. This “pattern/start pattern” specifying field 624 includes a “pattern type” option button 6241, a “comment processing” check box subfield 6242, a “pattern-embraced-by-content” check box 6243, a “reference-to-syntax-element-name” button 6244, and a “pattern description” text box 6245.

The “pattern type” option button 6241 is an option button for displaying and for selecting whether the target description pattern is a character string itself or a regular expression or a syntax element name. The “comment processing” check box subfield 6242 is a subfield containing a “forward comment contained” check box for displaying and for selecting whether a comment continuous forward of the syntax element is to be extracted or not in case the syntax element name is selected by the “pattern type” option button 6241, and a “backward comment contained” check box for displaying and for selecting whether a comment continuous backward of the syntax element is to be extracted or not in same case. The “pattern-embraced-by-content” check box 6243 is a check box for displaying and for selecting whether or not a character string corresponding to the description pattern is contained in the extraction target region when the start and the end are selected by the “pattern meaning” option button 622. The “reference-to-syntax-element-name” button 6244 is a button clicked for displaying a list of the respective syntax element names and their respective contents defined in the syntax decomposition definition file B when the syntax element name is selected by the “pattern type” option button 6241. Further, the “pattern description” text boxes 6245 are text boxes for displaying and for describing the whole description pattern itself of the selected element when the pattern itself is specified by the “pattern meaning” option button 622, or the start pattern itself when the start and the end are specified by the “pattern meaning” option button 622.

The “end pattern” specifying subfield 625 is a subfield for displaying and for setting a content of the end pattern of the element that is now being selected in case the start and the end are specified by the “pattern meaning” option button 622. The “end pattern” specifying subfield 625 includes a “pattern type” option button 6251, a “pattern-embraced-by-content” check box 6255, a “reference-to-syntax-element-name” button 6254, and a “pattern description” text box 6255. The functions of these components are absolutely the same as those of the “pattern/start pattern” specifying subfield 624, of which the repetitive explanations are omitted.

The “range restriction to parent” option button 626 is an option button for displaying and for selecting, in case the description pattern specified in the parent node of the element that is now being selected is a syntax element, whether a search range for the selected element is a whole region corresponding to the parent node “nothing”, or a segment of the syntax element region in the whole region corresponding to the parent node “syntax element”, or a comment region continuous forward of the syntax element region in the whole region corresponding to the parent node “forward comment”, or a comment region continuous backward of the syntax element region in the whole region corresponding to the parent node “backward comment”.

The “output tag name” text box 627 is a text box for displaying and for describing, after the region corresponding to the now-being-selected element has been extracted, tags (which are normally the same as the element names displayed in the “element name” text box 621) added in front and rear of region to be extracted on the basis of the element now being selected.

In a state where any one of the elements is selected, when the operator clicks the “delete” button 63, the set contents (the DTD structure and the description pattern information) of the selected element are deleted. In this case, the text boxes, the check boxes and the option buttons within the item input area 62 become all blank.

In the state where any one of the elements is selected, when the operator clicks the “cancel” button 64, the selection of that element is canceled. In this case, the text boxes and the option buttons within the item input area 62 become all blank, and a display color of the element name of the element within the DTD tree structure list box 61 returns to its original color.

In the state where any one of the elements is selected, when the operator clicks the “content reflection” button 66 after changing a description of any one of the text boxes, or changing a check content in any one of the check boxes or of option buttons within the item input area 62, the set content of that element become changed to a content displayed in the item input area 62 at the present.

In the state where any one of the elements is selected, when the operator clicks the “add as child” button 67 after changing description in at least the “element name” text box 621 within the item input area 63, a new element containing the set content displayed in the item input area 62 at the present is added as a child node of that element.

In the state where any one of the elements is selected, when the operator clicks the “add as younger brother” button 68 after changing description in at least the “element name” text box 621 within the item input area 63, a new element containing the set content displayed in the item input area 62 at the present, is added as a younger brother node of that element.

If the operator drags an element name displayed in the DTD tree structure list box 61 by use of the input device 8 and drops this element name onto any other element name, the element indicated by the dragged element name is changed as to be a child node of the element indicated by the element name onto which the former element name has been dropped.

Finally, when the operator clicks the “end-of-update” button 65, the DTD and pattern information” R is created or updated based on the set content of each current element.

The operator is able to edit the DTD and pattern information R as the operator intends by use of the DTD and pattern edit system 6 including the edit screen described above and the functions related to this edit screen.

The operator is able to create the DTD and pattern information” R from nothing by using this DTD and pattern edit system 6. The operator may complete the DTD and pattern information” R having been created by the DTD and pattern creation support system 7 shown in FIG. 1 by editing it with the DTD and pattern edit system 6.

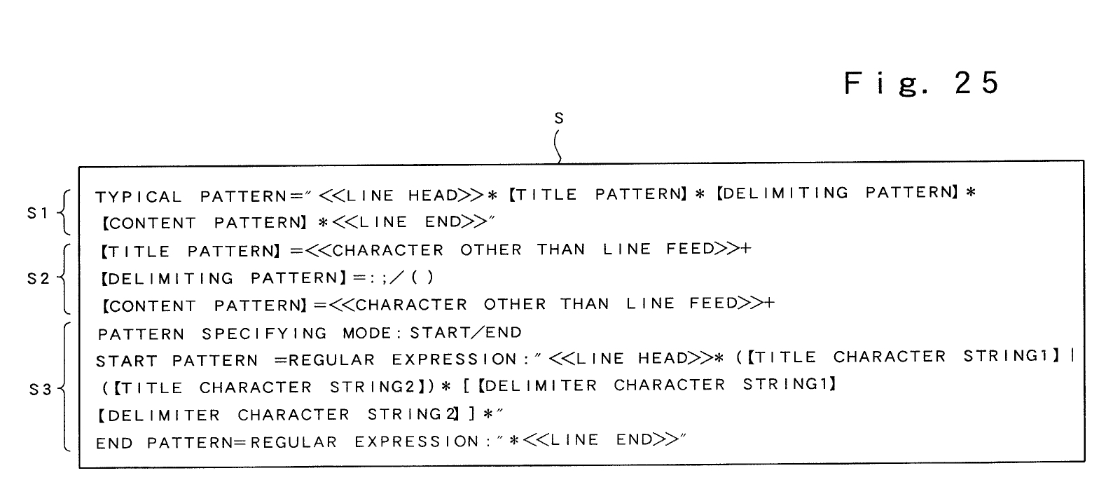

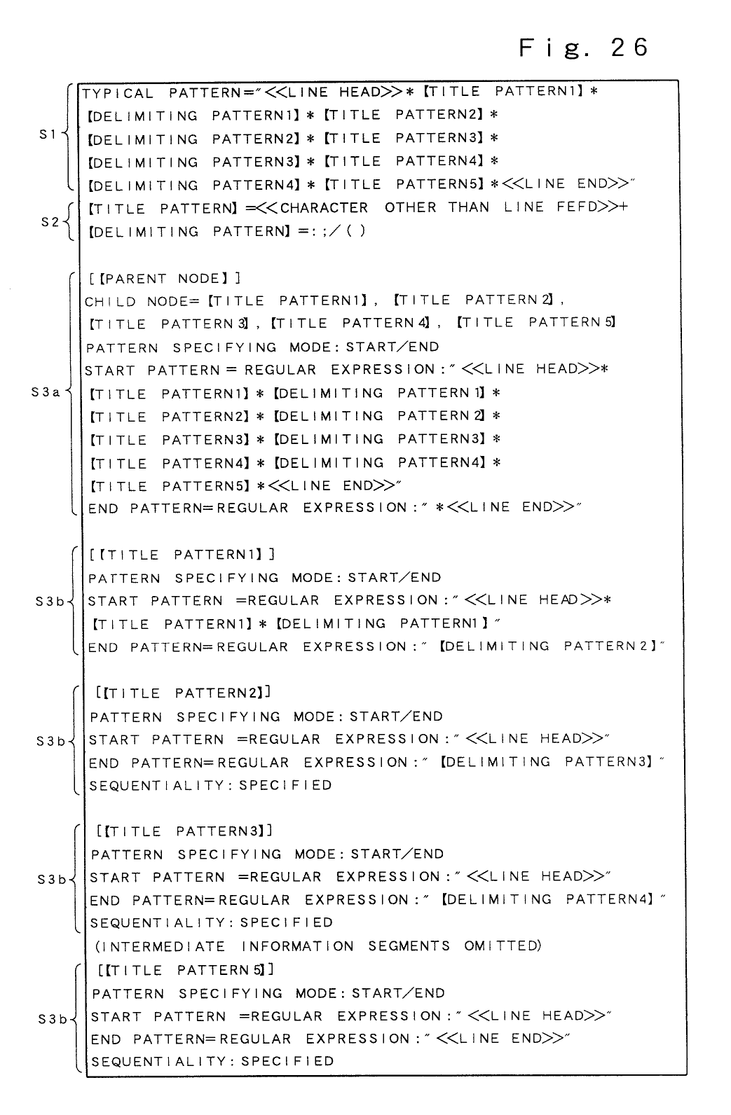

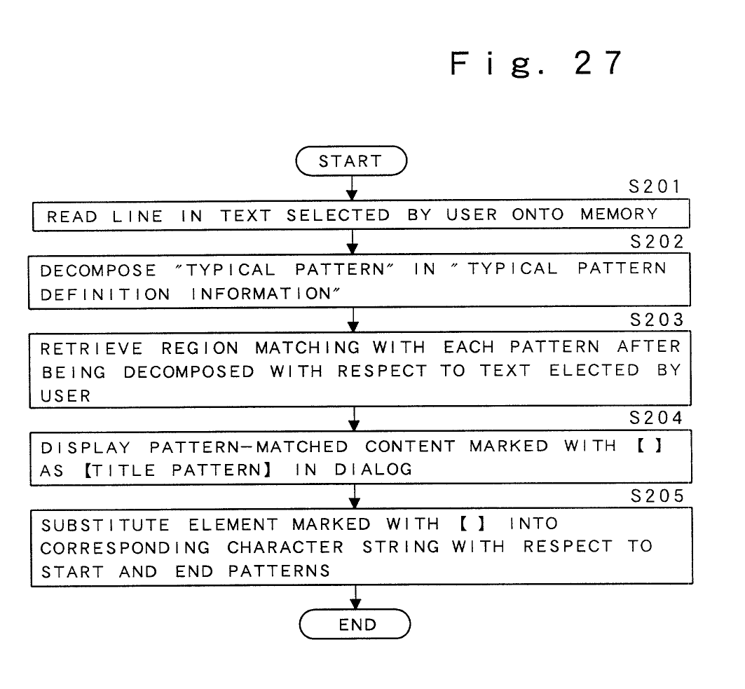

This DTD pattern creation support system 7 is classified as a text editor including GUI (Graphical User Interface, i.e., election screen) as illustrated in FIG. 24. The DTD pattern creation support system 7 has plurality pieces of typical pattern definition information S as shown in FIGS. 25 and 26. The typical pattern definition information S defines a model of the description pattern information for extracting, as an element, a typical character string pattern (which will hereinafter be simply referred to as a “typical pattern”) frequently occurred in a fixed type of document. Namely, as shown in FIGS. 25 and 26, each piece of typical pattern definition information S consists of a structure specifying information segment S1 for specifying an outline structure of the typical pattern, a character type specifying information segment S2 for specifying a character type in the regular expression that is usable as an individual element (embraced with cornered braces) constituting the outline structure of the typical pattern in the structure specifying information segment S1, and model information segment S3 for showing a model of the description pattern information per element in the DTD and pattern information R.

FIG. 25 shows, as in the case of:

“Name of company: Fujitsu Ltd.”,

an example of a typical pattern definition information S for the description pattern for extracting, as one element, such a typical pattern that an item name (title), a delimiter (delimit) and a specific content (content) follow 0 or more space(s) just after line head and there comes a line end. Therefore, in the structure specifying information segment S1, the outline structure is specified as “<<line head>>* [title pattern (corresponding to name of item)] * [delimiting pattern (corresponding to delimiter)] * [content pattern (corresponding to specific content)] *<<line end>>”. Further, in the character type specifying information segment S2, “<<other than line feed>>+” is specified with respect to [title pattern] and [content pattern], and “;:/()” is specified with respect to [delimiting pattern]. Further, in the model information segment S3, the pattern specifying mode is specified as “start and end”, and the start pattern is specified in the regular expression as “<<line head>>* [title character string 1] | [title character string 2] * [delimiter character string 1] | [delimiter character string 2] *”, and the end pattern is specified in the regular expression as “*<<line end>>”. [Title character string 1] and [title character string 2] are segments into which description eligible for item names are substituted. Similarly, [delimiter character string 1] and [delimiter character string 2] are segments into which description eligible for delimiter are substituted.

FIG. 26 shows an example of the typical pattern definition information S used for typical patterns extracted as one parent node and a plurality of child nodes. Hence, it includes, as the model information segment S3, one for extracting the parent node (which will hereinafter be referred to as “parent node model information segment S3a”), and ones for respectively extracting child nodes each corresponding to [title pattern] written in the structure specifying information segment S1 (which will hereinafter be called a “child node model information segment S3b”). Accordingly, the parent node model information segment S3a contains [title pattern 1]˜[title pattern 5] into which the element names of the respective child nodes are substituted. Further, in each piece of child node model information segment S3b, a relation with the elder brother node is specified such as “sequentiality=exhibited”.

The selection screen shown in FIG. 24 includes a “root element name” text box 71, a “sample” list box 72, a “tree” list box 73 and a typical pattern selection region 74. This typical pattern selection region 74 contains a plurality of pattern selection buttons 741 respectively corresponding to pieces of typical pattern definition information S. On the surface of each typical pattern selection button 741, a character string plainly showing a content of the structure specifying information segment S1 of the typical pattern definition information S corresponding to the button 741 is displayed. For instance, the typical pattern definition information S shown in FIG. 25 is made corresponding to the uppermost typical pattern selection button 741, and hence a character string “title:NNNNNNNNN” is displayed on this typical pattern selection button 741.

The DTD and pattern creation support system 7, when any one of the typical pattern selection buttons 741 is clicked after any line in the text displayed in the “sample” list box 72 has been selected by dragging, reads the typical pattern definition information S corresponding to this typical pattern selection button 741, and applies, to the selected line, the outline structure of the typical pattern that is specified in the structure specifying information segment S1, thereby extracting the character string corresponding to each of the elements constituting the outline structure. Then, the DTD and pattern creation support system 7 converts the extracted character string relative to each element so that it includes only the characters of the character type specified in the character type specifying information segment S2. Then, the DTD and pattern creation support system 7 substitutes the character string corresponding to each element after the conversion, into [] in the form information segment S3. Thus, the DTD and pattern creation support system 7 creates the description pattern information for extracting the child nodes (or the child nodes and grandchild nodes) of the root node having the element name described in the “root element name” text box 71, and adds the content of the description pattern to the DTD and pattern information R.

The “tree” list box 73 is a list box in which the element names of the respective elements contained in the DTD and pattern information R now of being created, are displayed in based on the tree structure representing the hierarchical structure thereof. Accordingly, each time the operator drags any line in the text displayed in the “sample” list box 72 and clicks any one of the typical pattern selection buttons 741, the element names of the child nodes (or the child nodes and the grandchild nodes) are added to the lower-order hierarchies of the root node displayed in the “tree” list box 73.

(Detailed Architecture and Processing Contents of Structural Documentation System)

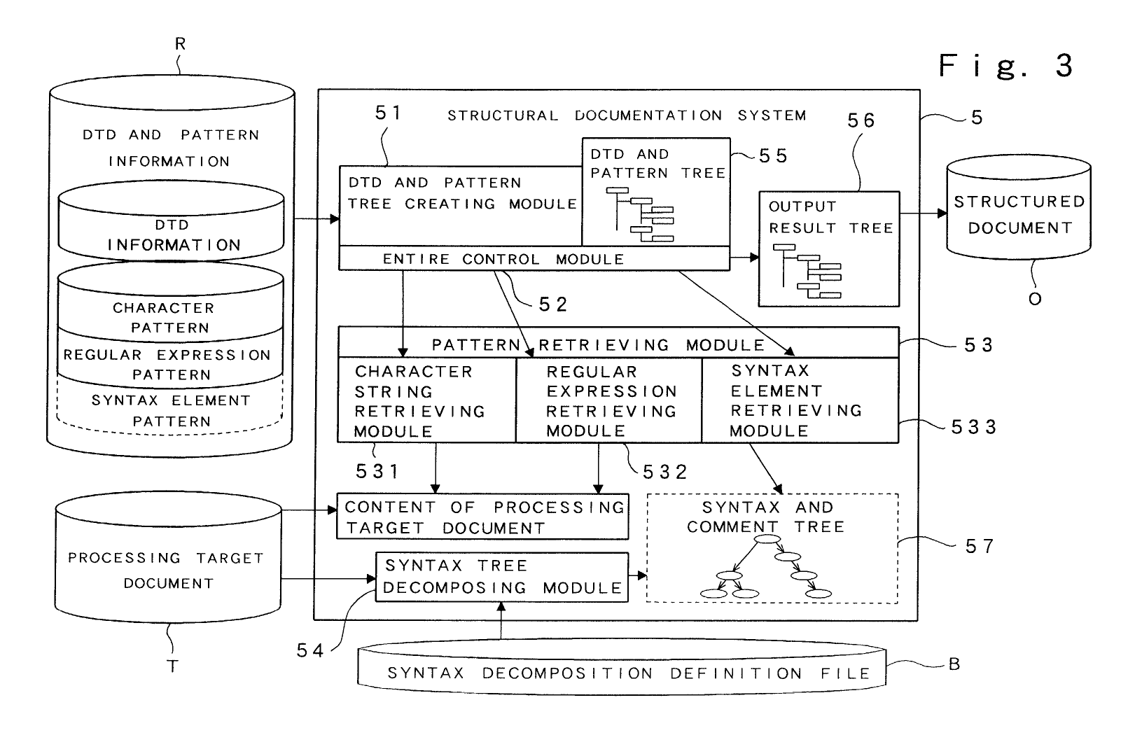

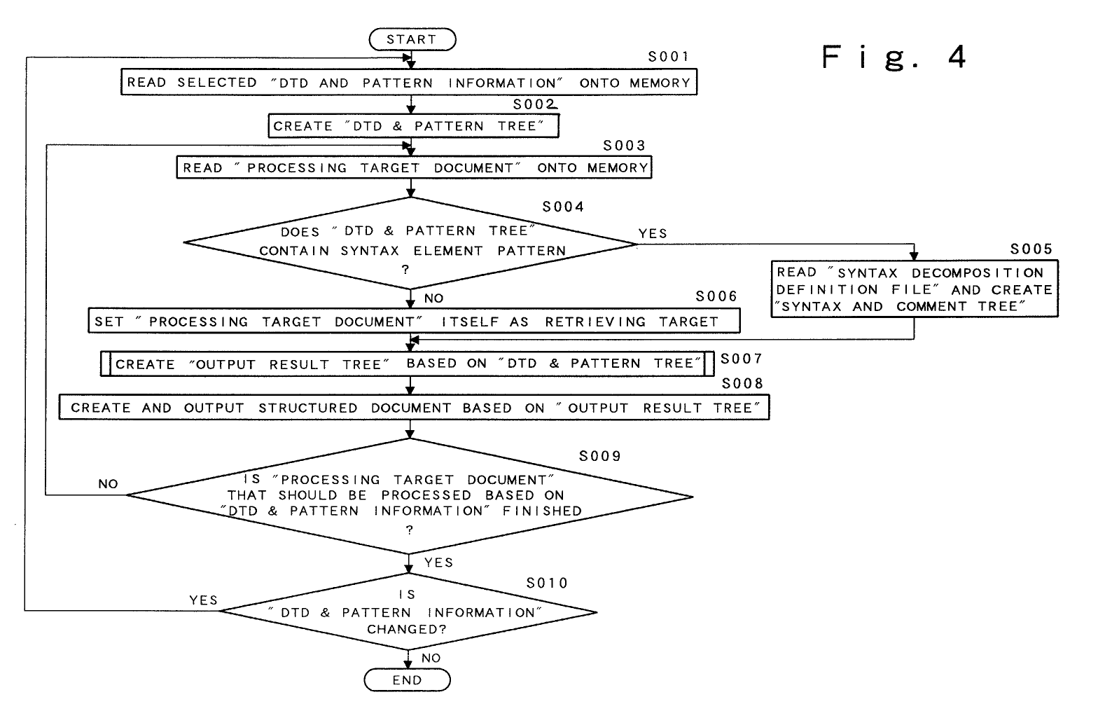

Next, a detailed architecture of the structural documentation system 5 will be described in combination with the processing contents thereof. FIG. 3 is a block diagram showing the detailed architecture of the structural documentation system 5 (a module architecture of a program configuring the structural documentation system 5). Further, FIGS. 4 through 6 are flowcharts showing the processing contents of the structural documentation system 5 (i.e., the processing contents of the CPU 1 based on the program configuring the structural documentation system 5).

As shown in FIG. 3, the structured documentation system 5 includes a DTD and pattern tree creating module 51, an entire control module 52, a pattern retrieving module 53 and a syntax tree decomposing module 54. Moreover, the pattern retrieving module 53 contains a character string retrieving module 531, a regular expression retrieving module 532 and a syntax element retrieving module 533.

The syntax tree decomposing module 54 is activated when the processing target document T is defined as the source program list described according to the BNF. The syntax tree decomposing module 54 analyzes the contents of the processing target document in accordance with the syntax composition definition file B, and configures a syntax tree/comment tree 57 as shown in FIG. 16 on the RAM 3 in accordance with the analyzed syntax structure of the processing target document T.

On the other hand, the DTD and pattern tree creating module 51 (corresponding to the reading module) reads the DTD and pattern information R selected by the operator, and analyzes contents thereof, whereby a DTD & pattern tree 55 as shown in FIGS. 7 and 12 is configured on the RAM 3.

The entire control module 52 sequentially reads the pattern description information of each element in the DTD and pattern tree 55 created by the DTD and pattern tree creating module 51, and requests the pattern retrieving module 53 to extract regions corresponding to the read-out pattern description information out of the processing target document T. On this occasion, if “repetition” is given to an element, the entire control module 52 continues to request the pattern retrieving module 53 to extract the regions corresponding to the pattern description information of the same element till the pattern retrieving module 53 is unable to inform the entire control module 52 of a extracted result. Then, the entire control module 52 assembles the regions that have been extracted out of the processing target document T by the pattern retrieving module 53, as an output result tree 56 shown in FIGS. 9 and 17, based on positions (i.e., DTDs in the DTD and pattern information R) of the respective elements in the DTD and pattern tree 55. Finally, the entire control module 52 adds tags corresponding to each element to front and rear of the region corresponding to each element in the output result tree 56, thereby outputting the structured document O as shown in FIG. 10 (which corresponds to a structured document creating module).

The pattern retrieving module 53 activates one of the retrieving modules corresponding to a type of the description pattern of element of which extraction has been requested by the entire control module 52. Specifically, it activates the character string retrieving module 531 in case the pattern description is the character string itself, the regular expression retrieving module 532 in case being the regular expression, or the syntax element retrieving module 533 in case being the syntax element. Then, the pattern retrieving module 53 commands the invoked retrieving module 531-533 to retrieve a character string corresponding to the description pattern. On this occasion, the pattern retrieving module 53 specifies, as a retrieving target range, the regions already extracted with respect to the parent node of the extraction target elements. If “Sequentiality exhibited” is specified in the extraction target elements, the pattern retrieving module 53 specifies, as the searching target range, regions subsequent to the regions already extracted with respect to the elder brother nodes within the regions already extracted with respect to the parent node. If “Repetition” is specified in the extraction target element, and if it has been already requested by the entire control module 52 to extract the same element, the pattern retrieving module 53 specifies, as the searching target range, regions subsequent to the regions extracted last time with respect to that element within the regions already extracted with respect to the parent node. Note that the pattern retrieving module 53, if the start pattern and the end pattern are different in terms of the type of the description pattern, invokes the character string retrieving module 531 and the regular expression retrieving module 532 corresponding to the respective description patterns, and commands the these modules 531, 532 to search the character strings corresponding to the respective description patterns.

When the pattern retrieving module 53 is informed of searched results from the character string retrieving module 531, the regular expression retrieving module 532 and the syntax element retrieving module 533 or when a set of information on the searched results from the character string retrieving module 531 and the regular expression retrieving module 532 is given in the case of commanding the retrieving modules 531, 532 to search the character strings corresponding to the start pattern and the end pattern, the pattern retrieving module 53 extracts a region corresponding to that element out of the processing target document T, referring to these searched results. Specifically, the pattern retrieving module 53 extracts a searched character string in case the description pattern of the whole element is specified, a region interposed between the searched character strings in case the start pattern and the end pattern are specified. Note that the extracted region contains the searched character string with respect to the start or end pattern if “Pattern embraced by content” is specified with respect to the start or end pattern in latter case. Then, the pattern retrieving module 53 notifies the entire control module 52 of the extracted region (which corresponds to a retrieving module).

The character string retrieving module 531 retrieves absolutely the same character string as the description pattern itself indicated by the pattern retrieving module 53. The regular expression retrieving module 532 retrieves the character string coincident with the regular expression in the description pattern indicated by the pattern retrieving module 53. The syntax element retrieving module 533 retrieves the same syntax element (or/and the comment continuous in front or rear thereof) as the description pattern indicated by the pattern retrieving module 53, and informs the pattern retrieving module 53 of retrieved syntax element.

The structured documentation system 5 configured by the respective modules described above is activated by a start command inputted by the operator via the input device 8, and, when the processing target document T and the DTD and pattern information R are selected by the operator, starts processing in procedures shown in FIG. 4.

Referring to FIG. 4, in first step S001 after the start, the DTD and pattern tree creating module 51 reads the DTD and pattern information R selected by the operator from the hard disk 2 onto the RAM 3.

In next step S002, the DTD and pattern tree creating module 51 configures the DTD and pattern tree 55 on the RAM 3 on the basis of the DTD and pattern information R read in S001.

In next step S003, the entire control module 52 reads the processing target document T selected by the operator from the hard disk 2 onto the RAM 3.

In next step S004, the entire control module 52 checks whether or not the DTD and pattern tree 55 created in S002 contains the description pattern consisting of the syntax element. Then, if the DTD and pattern tree 55 does not contain the description pattern consisting of the syntax element, the entire control module 52 determines the processing target document T itself as a searching target in S006, and thereafter advances the processing to S007. Whereas if the DTD and pattern tree 55 contains the description pattern consisting of the syntax element, the entire control module 52, in S005, reads the syntax decomposition definition file B and creates a syntax and comment tree 57 based on the processing target document T with reference to the syntax decomposition definition file B. After determining this syntax and comment tree 55 as a searching target, the processing proceeds to S007.

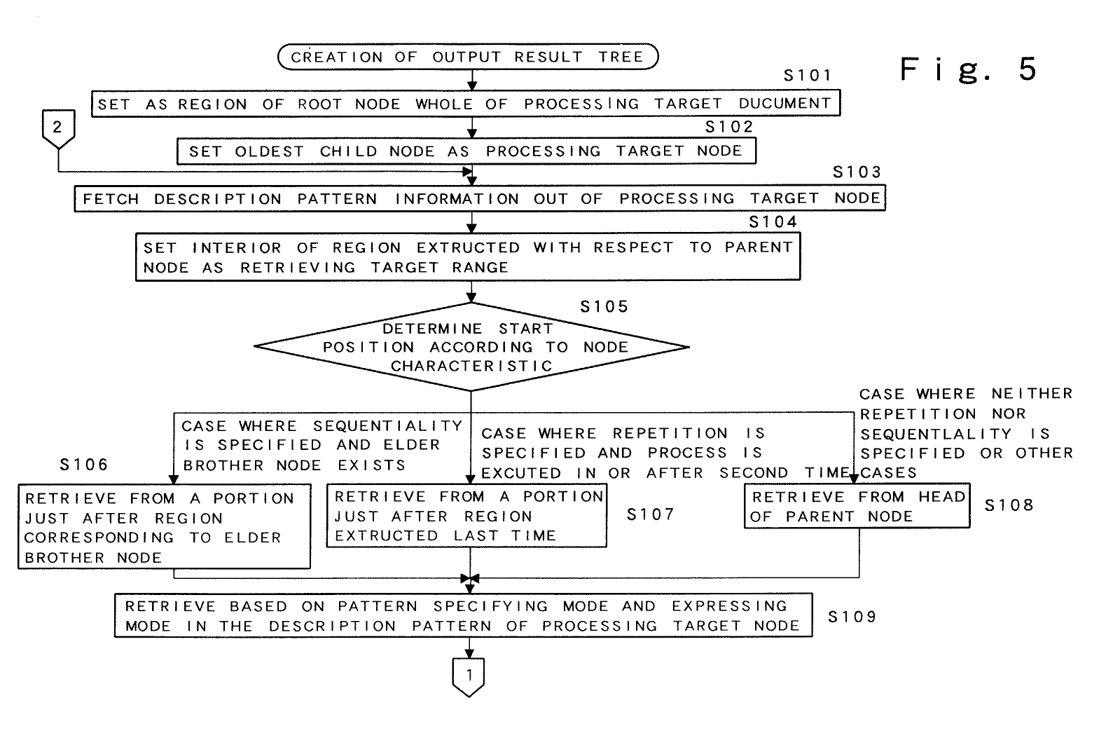

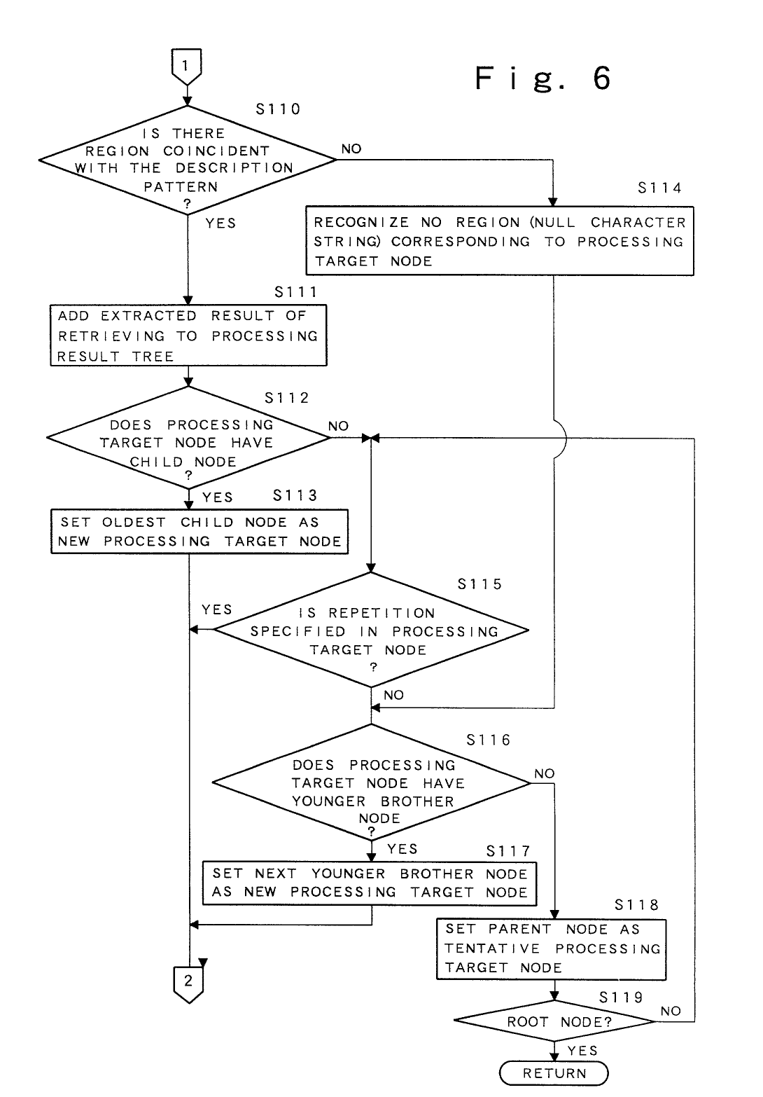

In S007, the entire control module 52 executes a process of creating the output result tree 56 in accordance with the DTD and pattern tree 55. FIGS. 5 and 6 are flowcharts showing an output result tree creating process subroutine executed in S007. In first step S101 after entering this subroutine, the entire control module 52 determines that the region corresponding to the root node in the DTD and pattern tree 55 represents the whole of processing target document T, and generates an output result tree 56 in which the whole of processing target document T is set to be an extraction result corresponding to the root node.

In next step S102, the entire control module 52 sets, as a processing target node, the oldest child node of the root node in the DTD and pattern tree 55. Next, the entire control module 52 executes a loop processes of S103 through S113. In first step S103 after entering this loop processes, the entire control module 52 fetches the description pattern specified in the element out of the processing target node in the DTD and pattern tree 55.

In next step S104, the entire control module 52 determines an interior of the region corresponding to the parent node of the processing target node (the low-order hierarchy of the parent node with respect to the syntax tree/comment tree 57) as a retrieving target range in which the region (a character string itself in case the description pattern of the whole element being specified, a region interposed between retrieved character strings in case the start pattern and the end pattern being specified) coincident with the description pattern fetched in S103 is to be retrieved.

In next step S105, the patterns retrieving module 53 determines a start position of retrieving within the region of the parent node in accordance with characteristics (such as whether the sequentiality is exhibited or not, whether the elder brother node exits or not, and whether the same process has been already executed with respect to the node with “Repetition” specified) of the processing target node. Namely, if the sequentiality is exhibited and the elder brother node exits, (excluding, however, a case where the processing target node is specified with the repetition and same process with respect to the processing target node has been already executed), in S106, the pattern retrieving module 53 determines to retrieve that from a portion after the already-retrieved region corresponding to the elder brother node just anterior thereto. If the processing target node is specified with the repetition and same process with respect to the processing target node has been already executed, in S107, the pattern retrieving module 53 determines to retrieve that from a portion after the region retrieved last time with respect to the processing target node. If neither the repetition nor the sequentiality is specified or in other cases, the pattern retrieving module 53 determines to retrieve that from the head of the parent node in S108.

In any case, in next step S109, the pattern retrieving module 53 retrieves and extracts the region coincident with the description pattern fetched in step S103 within the searching target region on the basis of a description pattern specifying mode (whether the description pattern of the whole element is specified or the start and end patterns of the element is specified) and an expression mode (whether the character string itself is specified or the regular expression in the character string is specified)in the description pattern of the processing target node. The entire control module 52 is notified of a result extracted by this retrieving process.

In next step S110, the entire control module 52 checks whether or not the region coincident with the description pattern of the processing target node is extracted out of the retrieving target region as a result of the retrieval in S109. Then, if the coincident region is extracted, the entire control module 52 adds in S111 the node of which content is the character string contained in the extracted region, to the low-order hierarchy of the parent node in the output result tree 56.

In next step S112, the entire control module 52 checks whether or not the processing target node has the child node. Then, if the processing target node has the child node, the entire control module 52, sets as a new processing target, the oldest child node among the present processing target nodes in S113, and returns the processing to S103.

As a result of repeating the loop of processes in S103 through S113 explained above, if it is judged in S110 that the region coincident with the description pattern of the processing target node is not extracted out of the retrieving target region as a consequence of the retrieval in S109, the entire control module 52 acknowledges in S114 that there is no region corresponding to the present processing target node, and adds the node of which content is a null character string to the low-order hierarchy of the parent node in the output result tree 56. After a completion of this step S114, the entire control module 52 advances the processing to S116.

As a result of repeating the loop of processes in S103 through S113 described above, if it is judged in S112 that the processing target node has no child node (if the processing target node is a so-called leaf node), the entire control module 52 advances the processing to S115.

In S115, the entire control module 52 checks whether or not the repetition is specified in the processing target node. Then, if the repetition is specified therein, the entire control module 52 does not change the processing target node, and returns the processing to S103.

Whereas if it is judged in S115 that the repetition is not specified in the processing target node, the entire control module 52 advances the processing to S116.

In S116, the entire control module 52 checks whether the processing target node has a younger brother node. Then, if the younger brother node is contained, the entire control module 52 sets a next younger brother node as a new processing target node in S117, and returns the processing to S103.

Whereas if judging in S116 that the processing target node has no younger brother, the entire control module 52 sets, as a tentative processing target node, the parent node of the present processing target node in S118, and advances the processing to S119. In S119, the entire control module 52 checks whether or not the tentative processing target node is the root node. Then, if the tentative processing target node is not the root node, the entire control module 52 returns the processing to S115. In this case, the entire control module 52 checks whether or not the repetition is specified in the tentative processing target node in S115, then, if the repetition is specified, the entire control module 52 deals with the tentative processing target node as an original processing target node and returns the processing to S103. By contrast, if the repetition is not specified in the tentative processing target node, the entire control module 52 checks in S116 whether or not the tentative processing target node has a younger brother node. Then, if the tentative processing target node has a younger brother node, the entire control module 52 sets this younger brother node as a new processing target node (S117). If having no younger brother node, a further parent node of the present tentative processing target node is set as a new tentative processing node (S118).

The processes in S103 through S119 described above are repeated, thereby implementing the retrieval based on all the nodes configuring the DTD and pattern tree 55. Then, upon completing the retrieval based on all the nodes, it is judged in S119 that the tentative processing target node is the root node, and the output result tree creation subroutine comes to an end, thereby the processing returns to the main routine in FIG. 4. Accordingly, at this point of time, the output result tree 56 is completed.

In the main routing in FIG. 4 to which the processing has been returned, the processing proceeds to S008 from S007. In S008, the entire control module 52 creates the structured document O on the basis of the output result tree 56 completed as a result of the processing in S007. To be more specific, the entire control module 52 adds the tags corresponding to the nodes (elements) in front and rear of the regions corresponding to these nodes (so-called leaf nodes) having no child node. Next, the entire control module 52 puts the brother nodes together into one group, and adds tags corresponding to the parent node common to these nodes in front and rear of this whole group. Thus, the tags are sequentially added from the lowest-order hierarchy node toward the higher-order nodes, and finally the tags corresponding to the root node are added, thereby completing the structured document O. The entire control module 52 outputs the thus completed structured document O to the hard disk 2 and the display 4 as well.

In next step S009, the entire control module 52 checks whether or not the operator selects other processing target document T that should be processed based on the DTD and pattern information” R read in S001. When judging that the operator has selected other processing target document T, the entire control module 52 returns the processing to S003.

Whereas if judging that the operator does not select other processing target document T, the entire control module 52 checks in S010 whether or not the operator inputs information meaning that the DTD and pattern information R referred to at the present be changed. Then, in the case he or she has inputted the information meaning that the DTD and pattern information R be changed, the entire control module 52 returns the processing to S001. Whereas if the operator has inputted no such information that the DTD and pattern information R be changed, the processing by the structural documentation system 5 is finished.

(Example of Function of Structured Documentation System)

Next, a specific example of the function of the structural documentation system 5 for executing the processes in the procedures described above, will be explained.

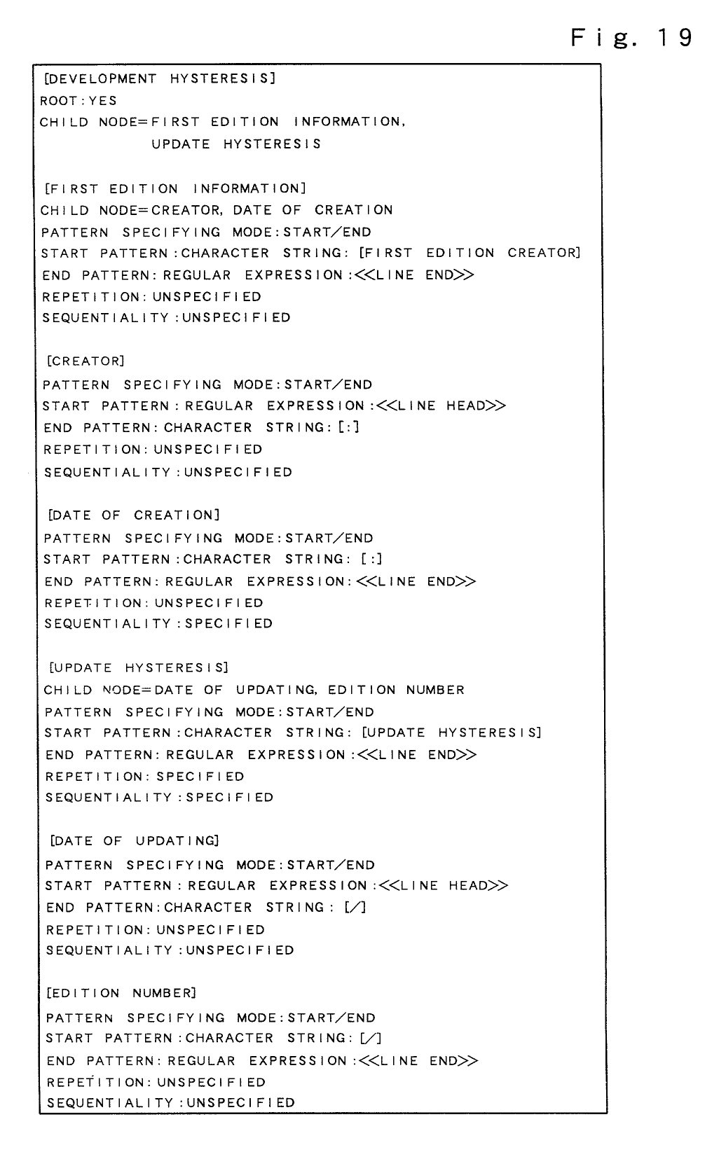

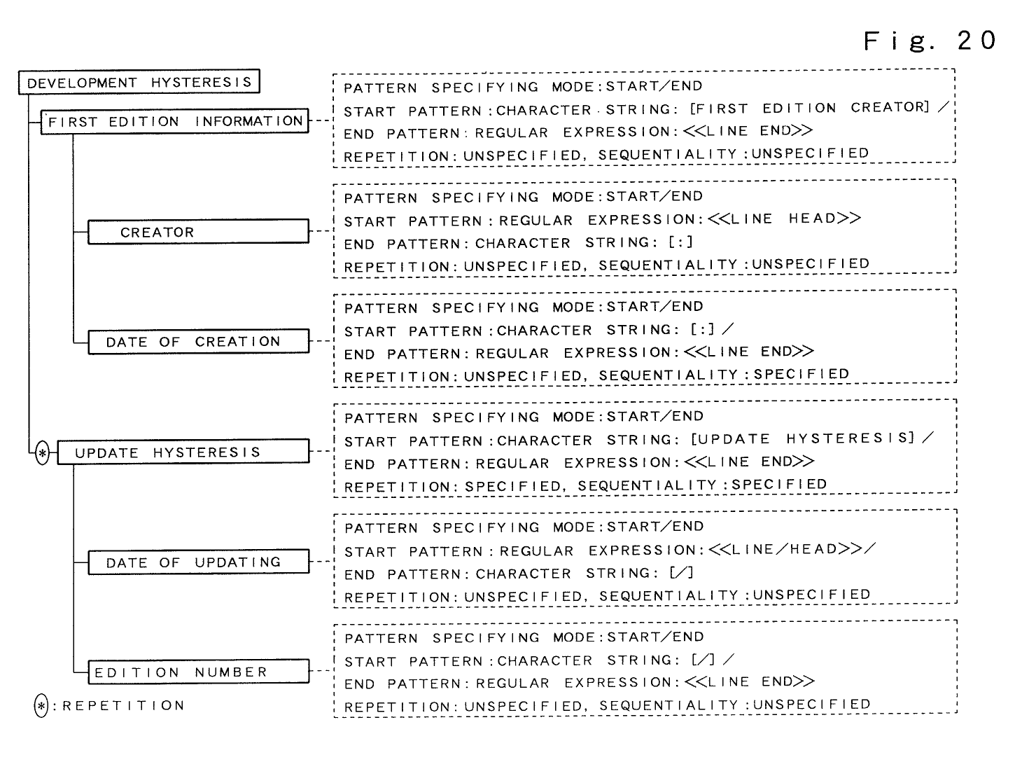

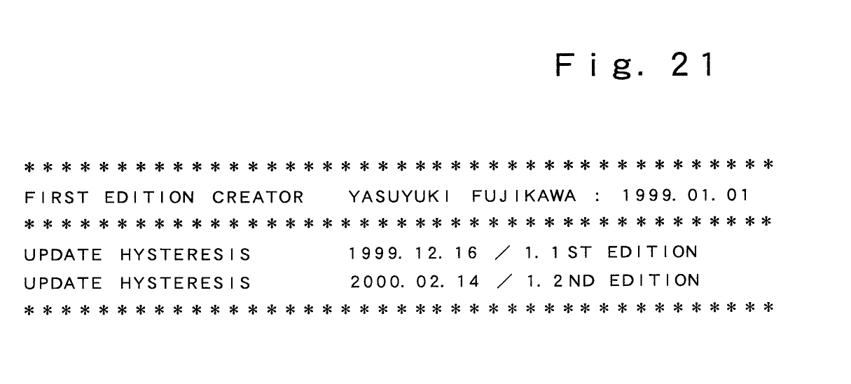

Now, it is assumed that the operator selects the DTD and pattern information R having contents as shown in FIG. 19 and further selects the processing target document T having contents as shown in FIG. 21. Then, the DTD and pattern tree creating module 51 of the structural documentation system 5 analyzes the contents of the DTD and pattern information R, thereby creating the DTD and pattern tree 55 as shown in FIG. 20 (S001, S002).

The entire control module 52 refers to this DTD and pattern tree 55, and at first determines that a region corresponding to a root node “development hysteresis” represents the whole of this processing target document T (S101). Next, the entire control module 52 continues to set the child nodes of the root node as the processing target nodes in due order (S102, S103˜S113).

To begin with, the entire control module 52 sets an oldest child node “first edition information” of the root node as a processing target node (S102). Then, the entire control module 52 refers to a piece of description pattern information on the node “first edition information” in the DTD and pattern tree 55 (S103), and sets a region (the whole of the processing target document T) corresponding to the parent node “development hysteresis” as the retrieving target range(S104). Then, nether the repetition nor the sequentiality is specified in the description pattern information, and hence the pattern retrieving module 53 starts retrieving from the head of the region corresponding to the parent node “development hysteresis” (S108, S109). In this retrieval, since the start and the end patterns of the element are specified as the pattern specifying mode in the description pattern information, since the start pattern is specified as “first edition creator” consisting of a character string itself, and since the end pattern is specified as “<<line end>>” in the regular expression, an information segment such as:

“Yasuyuki Fujikawa: 1999.01.01”

is detected as a region coincident with the description pattern information. Accordingly, this region is extracted as a region corresponding to the node “first edition information” and added to the output result tree 56 (S111).

Next, the entire control module 52 sets a oldest child node “creator” of that node “first edition information” as a new processing target node (S112, S113). Then, the entire control module 52 refers to the description pattern information on this node “creator” in the DTD and pattern tree 55 (S103), and sets the region:

“Yasuyuki Fujikawa: 1999.01.01”

that corresponds to the parent node “first edition information” as a retrieving target region (S104). Since neither the repetition nor the sequentiality is specified in this piece of description pattern information, the pattern retrieving module 53 starts retrieving from the head of the region corresponding to the parent node “first edition information” (S108, S109). In this retrieval, since the start and end patterns of the element are specified as the pattern specifying mode in the description pattern information, since the start pattern is specified as “<<linehead>>” in the regular expression, and since the end pattern is specified as “:” consisting of the character string itself, an information segment such as:

“Yasuyuki Fujikawa”

is detected as a region coincident with the description pattern information. Accordingly, this region is extracted as a region corresponding to the node “creator” and added to the output result tree 56 (S111).

This node “creator” has no child node (S112), and no repetition is specified in the description pattern information thereof (S115). The entire control module 52 therefore sets a next younger brother node “date of creation” of that node “creator” as a new processing target node (S116, S117). Then, the entire control module 52 refers to the description pattern information on this node “date of creation” in the DTD and pattern tree 55 (S103), and sets the region:

“Yasuyuki Fujikawa: 1999.01.01”

that corresponds to the parent node “first edition information” as a retrieving target region (S104). Since no repetition is specified in this piece of description pattern information, however, the sequentiality is specified therein, the pattern retrieving module 53 starts retrieving from a portion just after the region corresponding to the elder brother node “creator” (S106, S109). In this retrieval, since the start and end patterns of the element are specified as the pattern specifying mode in the description pattern information, since the start pattern is specified as “:” consisting of character string itself, and the end pattern is specified as <<line end>>” in the regular expression, an information segment such as:

“1999.01.01”

is detected as a region coincident with the description pattern information. Accordingly, this region is extracted as a region corresponding to the node “date of creation” and added to the output result tree 56 (S111).

The node “date of creation” has no child node (S112), no repetition is specified in the description pattern information thereof (S115), and it has no younger brother node (S116). Therefore, the entire control module 52 sets a next younger brother node “update hysteresis” of the parent node “first edition information” as a new processing target node (S118, S119, S115˜S117). Then, the entire control module 52 refers to the description pattern information on this node “update hysteresis” in the DTD and pattern tree 55 (S103), and sets the region (the whole of the processing target document T) corresponding to the parent node “development hysteresis” as a retrieving target region (S104). Since the sequentiality is specified in this piece of description pattern information, the pattern retrieving module 53 starts retrieving from a portion just after the region corresponding to the elder brother node “first edition information” (S106, S109). In this retrieval, since the start and end patterns are specified as the pattern specifying mode in the description pattern information, since the start pattern is specified as “update hysteresis” consisting of character string itself, and since the end pattern is specified as <<line end>>” in the regular expression, an information segment such as:

“1999.12.16/1.1th edition”

is detected as a region coincident with the description pattern information. Accordingly, this region is extracted as a region corresponding to the node “date of creation” and added to the output result tree 56 (S111).

Next, the entire control module 52 sets the oldest child node “date of updating” as a new processing target node (S112, S113). Then, the entire control module 52 refers to the description pattern information on this node “date of updating” in the DTD and pattern tree 55 (S103), and sets the region:

“1999.12.16/1.1th edition”

that is extracted corresponding to the parent node “update hysteresis” as a retrieving target region (S104). Since neither repetition nor the sequentiality is specified in this piece of description pattern information, the pattern retrieving module 53 starts retrieving from a portion just after the head of the region corresponding to the parent node “update hysteresis” (S108, S109). In this retrieval, the start and end patterns are specified as the pattern specifying mode in the description pattern information, since the start pattern is specified as “<<line head>>” in the regular expression, and since the end pattern is specified as “/” consisting of the character string itself, an information segment such as:

“1999.12.16”

is detected as a region coincident with the description pattern information. Accordingly, this region is extracted as a region corresponding to the node “date of updating” and added to the output result tree 56 (S111).

This node “date of updating” has no child node (S112), and no repetition is specified in the description pattern information thereof (S115). The entire control module 52 therefore sets a next younger brother node “edition number” as a new processing target node (S116, S117). Then, the entire control module 52 refers to the description pattern information on this node “edition number” in the DTD and pattern tree 55 (S103), and sets the region:

“1999.12.16/1.1th edition”

that has been extracted corresponding to the parent node “update information” at a retrieving target information (S104). Since no repetition is specified in this piece of description pattern information, however, the sequentiality is specified therein, the pattern retrieving module 53 therefore starts retrieving from a portion just after the elder brother node “date of updating” (S106, S109). In this retrieval, the start and end patterns are specified as the pattern specifying mode in the description pattern information, since the start pattern is specified as “/” consisting of the character string, and since the end pattern is specified as <<line end>>” in the regular expression, an information segment such as:

“1.1th edition”

is detected as a region coincident with the description pattern information. Accordingly, this region is extracted as a region corresponding to the node “edition number” and added to the output result tree 56 (S111).

This node “edition number” has no child node (S112), no repetition is specified in the description pattern information thereof (S115), and it has no younger brother node (S116). Therefore, and the entire control module 52 sets the parent node “update hysteresis” as a tentative processing target node (S118). Since the repetition is specified in the description pattern information of this tentative processing target node “update hysteresis” (S115), the entire control module 52 repeats the extraction of the region on the basis of this node “update hysteresis”. In this case, since the processing is executed second time, the entire control module 52 starts retrieving from a portion just after this region:

“1999.12.16/1.1th edition”

that has been extracted in the processing of extraction based on the node “update hysteresis” executed last time within the region corresponding to the parent node “development hysteresis” which is the whole of the processing target document T (S107, S109). In this retrieval, an information segment such as:

“2000.02.14/1.2th edition”

is detected at first as a region coincident with the description pattern information. Further, in the following retrieval with respect to the node “date of updating” and the node “edition number”, information segments such as:

“2000.02.14”

“1.2th edition”

are respectively detected.

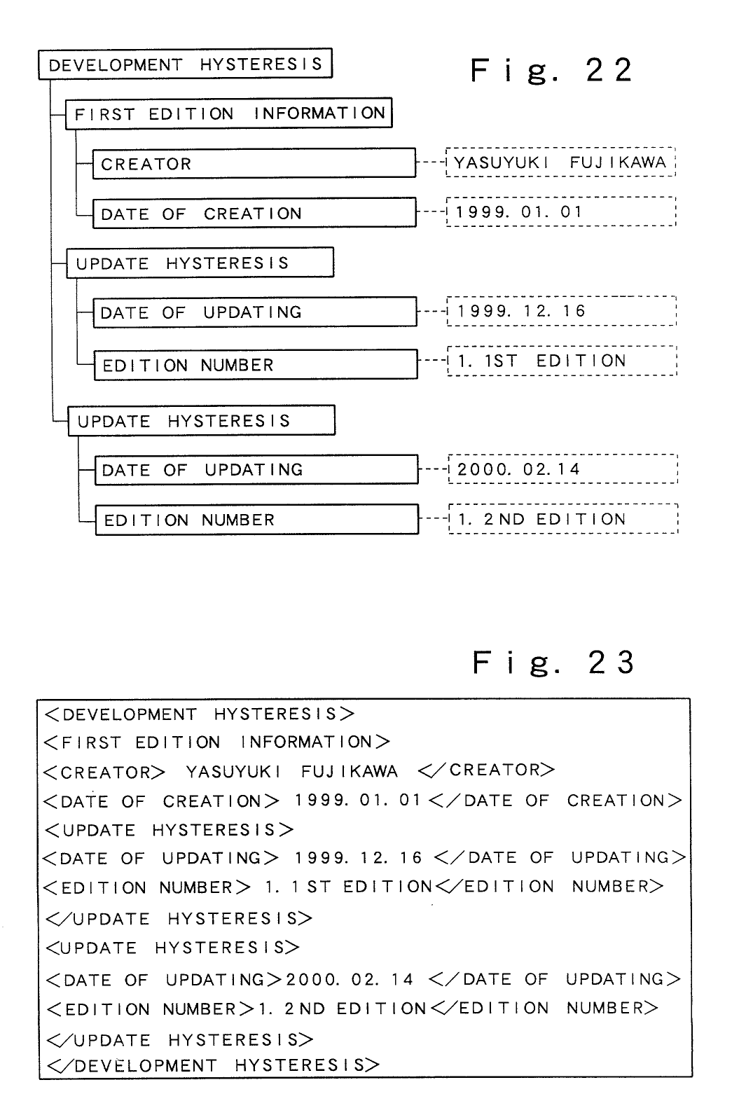

Thereafter, the entire control module 52 tries to retrieve again the node “update hysteresis”, however, the region coincident with the description pattern is not detected any longer (S110). Further, node “update hysteresis” has no younger brother node. Therefore, the entire control module 52 temporarily sets the parent node “development hysteresis” as a tentative processing target node (S118). Because of this processing target node “development hysteresis” being defined as the root node (S119), the entire control module 52 finishes retrieving and creating the output result tree 55. The DTD and pattern tree 55 at this point of time is as shown in FIG. 22.

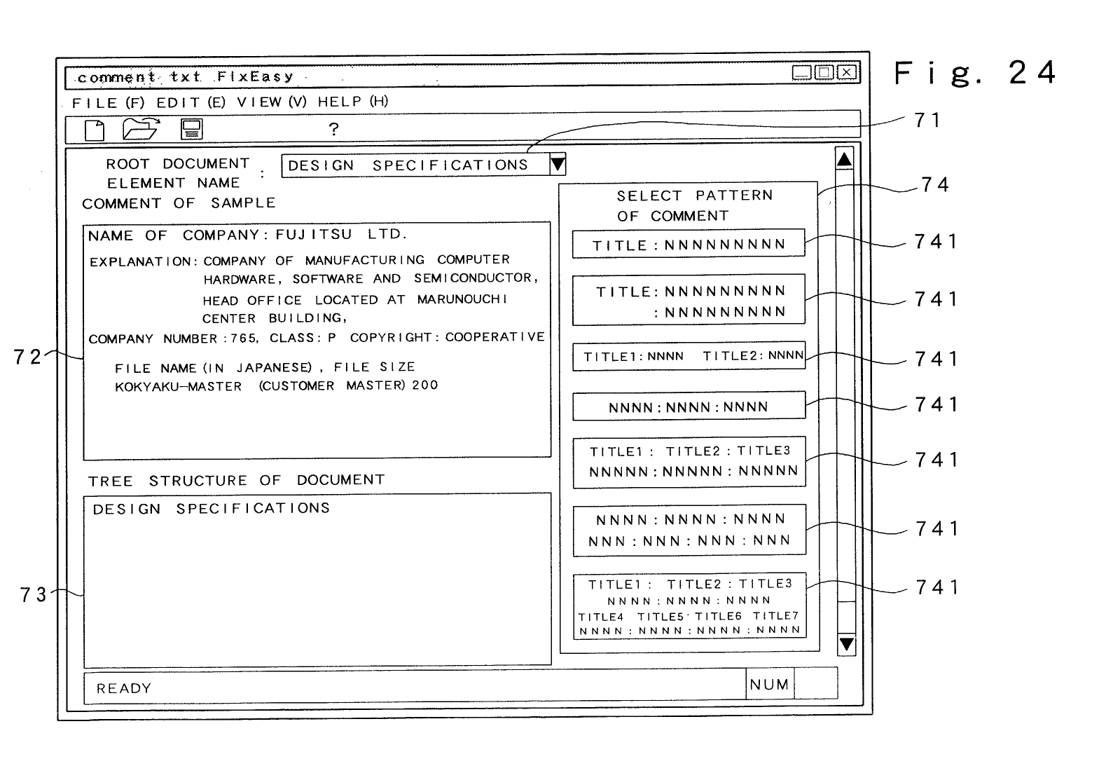

The entire control module 52, based on this DTD and pattern tree 55, adds the tags to the character strings given to the respective nodes, thereby creating and outputting a structured document as shown in FIG. 23 (S008).

(Processing Contents of DTD and Pattern Creation Support System)

Next, the processing contents by the DTD and pattern creation support system 7 described above will be explained in detail. FIG. 27 is a flowchart showing the processing contents of the DTD pattern creation support system 7 (i.e., the processing contents by the CPU 1 based on the program configuring the DTD and pattern creation support system 7).

This DTD and pattern creation support system 7 is activated by a boot command inputted by the operator via the input device 8. Then, a selection screen as shown in FIG. 24 is displayed on the display 4, and corresponding pieces of typical pattern definition information S are related to the respective typical pattern selection buttons 741 on this selection screen. Subsequently, when a sample of the processing target document T is selected by an information input by the operator via the input device 8, the DTD and pattern creation support system 7 reads the sample of the processing target document T from the had disk 2 onto the RAM 3, and displays a text content in the “sample” list box 72 on the selection screen. Then, the operator, after selecting any one of line of the text displayed in the “sample” list box 72 by dragging it, detects the typical pattern approximate most to the pattern of this selected line and clicks the typical pattern selection button 741 corresponding to this detected typical pattern, whereby the DTD and pattern creation support system 7 starts the processing in FIG. 27.

In the processes shown in FIG. 27, the DTD and pattern creation support system 7, in first step S201 after the start, reads the line selected by the operator into an operation area on the RAM 3.

In next step S202, the DTD and pattern creation support system 7 reads, into the operation area on the RAM 3, the typical pattern definition information S related to the typical pattern selection button 741 clicked by the operator. Then, the DTD and pattern creation support system 7 decomposes a outline structure of the typical pattern written in the structure specifying information segment S1 of the thus read typical pattern definition information S. To be more specific, respective elements (embraced by cornered braces) in the outline structure of the typical pattern are distinguished from other portions.

In next S203, the DTD and pattern creation support system 7 specifies the elements (embraced by the cornered braces) decomposed in S202 one by one as a retrieving target from the head thereof, and retrieves an area coincident with the regular expression pattern indicated in the character type specifying information segment S2 with respect to the specified retrieving target element out of the text read into the operation area on the RAM 3 in S201. At this time, the DTD and pattern creation support system 7, if the first element is set as the retrieving target, retrieves from the head of the text read into the operation area on the RAM 3 in S201, and, if one of the elements subsequent thereto is set as the retrieving target, retrieves from a portion just after the area retrieved with respect to the element just anterior thereto.

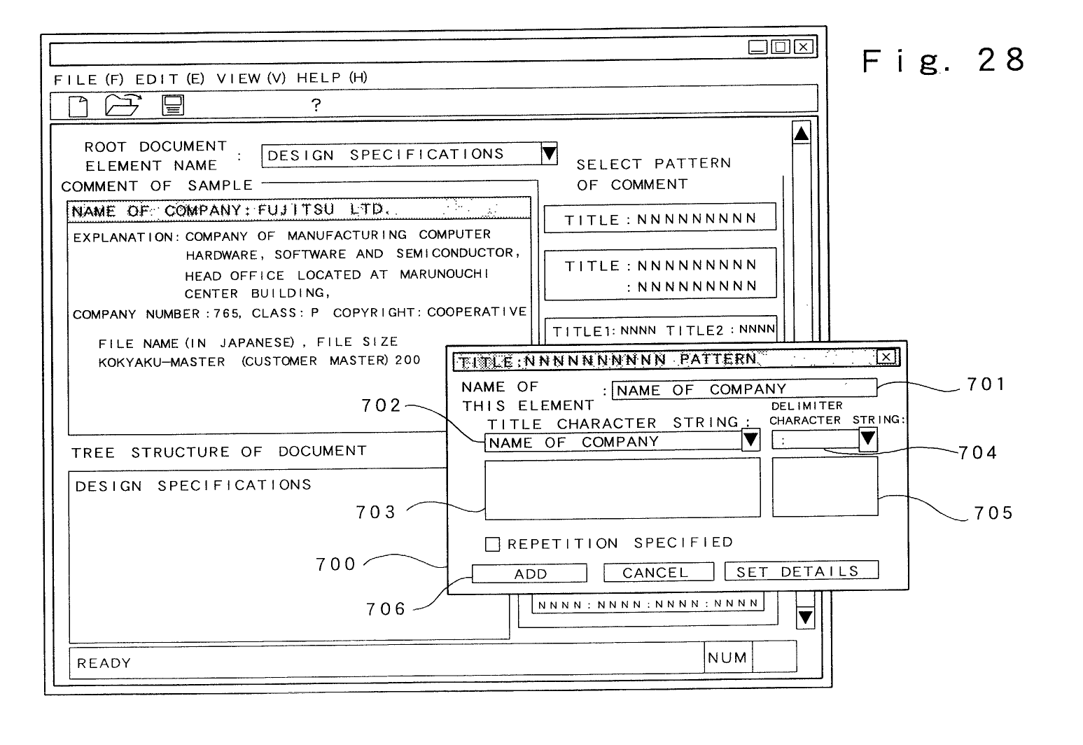

In next step S204, the DTD and pattern creation support system 7 displays a dialog 700 as shown in FIG. 28 with it being superimposed on the selection screen. This dialog 700 is created for every piece of typical pattern definition information S. The dialog 700 in the example shown in FIG. 28 is created related to the typical pattern definition information shown in FIG. 25, and therefore includes a “element name” text box 701, a “title character string” text box 702, a “title character string” list box 703, a “delimiter character string” text box 704, a “delimiter character string” list box 705, and an “add” button 706. The DTD and pattern creation support system 7 displays the area detected with respect to each element in S203 in the text boxes 702, 704 corresponding thereto.

FIG. 28 shows a case where after a line:

“Name of company: Fujitsu Ltd.”

in the text displayed in the “sample” list box 72 selected, the typical pattern selection button 741 related to the typical pattern information S shown in FIG. 25 is clicked. Therefore, the detected area “Name of company” with respect to the element [title pattern] is displayed in the “title character string” text box 702, and a detected symbol “:” with respect to the element [delimiting pattern] is displayed in the “delimiter character string” text box 704.

Note that the operator is able to input a character string which can substitute for the character string displayed in the “title character string” text box 702 to the “title character string” list box 703. Similarly, the operator is able to input a character string which can substitute for the character string displayed in the “delimiter character string” text box 704 to the “delimiter character string” list box 705. Further, the operator is able to input an element name of the element to which the description pattern to be created is specified, to the “element name” text box 701. Then, when the operator clicks “add” button 706, the DTD and pattern creation support system 7 advances the processing to S205.

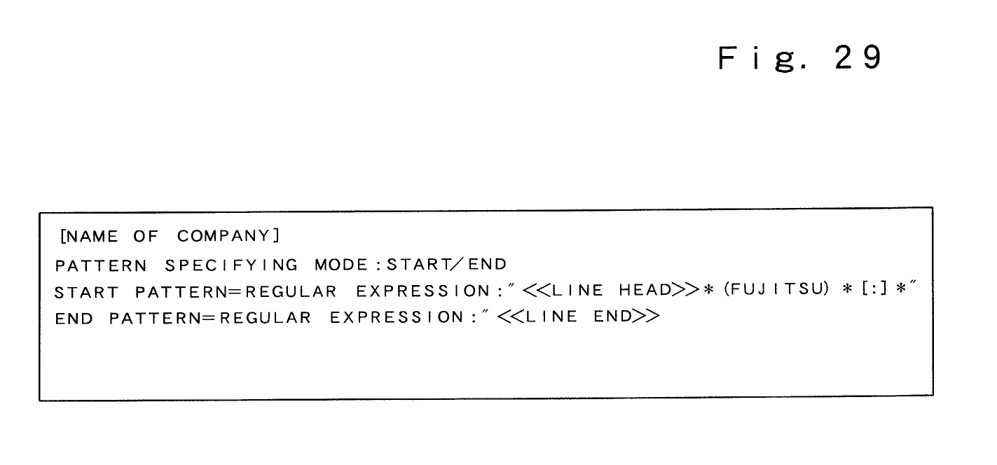

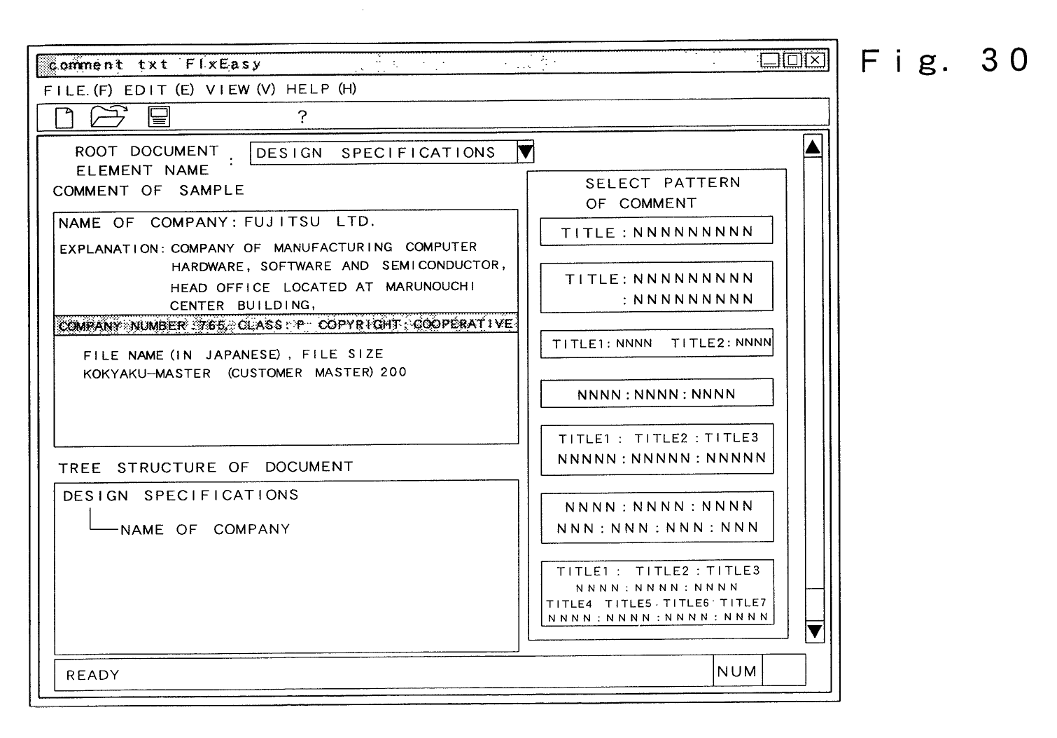

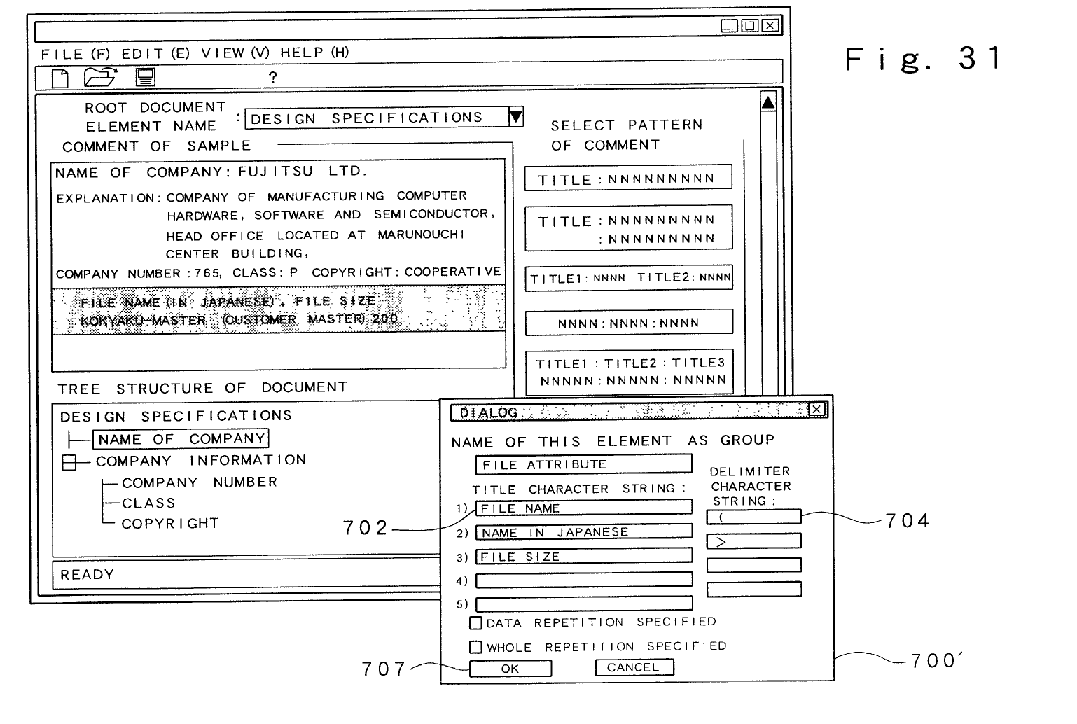

In S205, the DTD and pattern creation support system 7 converts the character string displayed in each column of the dialog 700 into an expression (a more tangible expression than the expression specified in the character type specifying information segment S2) specified in the model information segment S3, and substitutes the converted expression into [] in the model of the description pattern information in the model information segment S3 within the typical pattern information S. In the examples shown in FIGS. 25 and 26, the character string displayed in the “title character string” text box 702 is converted into a regular expression and substituted into [title character string 1], and the character string displayed in the “title character string” list box 703 is converted into a regular expression and substituted into [title character string 2]. The character string displayed in the “delimiter character string” text box 704 is converted into a regular expression and substituted into [delimiter character string 1], and the character string displayed in the “delimiter character string” text box 705 is substituted into [delimiter character string 2]. With this operation, the model in the model information segment S3 becomes the description pattern information specified with respect to the element having the element name displayed in the “element name” text box 701, and is added to the DTD and pattern information R. FIG. 29 shows pieces of description pattern information created when the “add” button 706 is clicked in a state shown in FIG. 28. Note that, as discussed above, at this point of time, the element name “name of company” is displayed in the “tree” list box 73 as a child node of the root node “design specifications”, as shown in FIG. 30.

Hereinafter, each time the operator selects an arbitrary line in the text displayed in the “sample” list box 73 and clicks any one of the typical pattern selection buttons 741, the description pattern information on a new child node (or the child node and a grandchild node) is created and added to the DTD and pattern information R.

FIG. 31 shows a dialog 700′ in such a case that, for example, in the state where an element “company information” is added as a child node of the root node “design specifications”, the typical pattern selection button 741 related to the typical pattern information S shown in FIG. 26 is clicked, after a line:

“file name <name in Japanese> file size KOKYAKU-MASTER <client master> 200”

in the text displayed in the “sample” list box 72 is selected. This dialog 700′ contains five pieces of “title character string” text boxes 702, and four pieces of “delimiter character string” text boxes 704. Further, an “OK” button 707 is provided as a substitute for the “add” button 706.

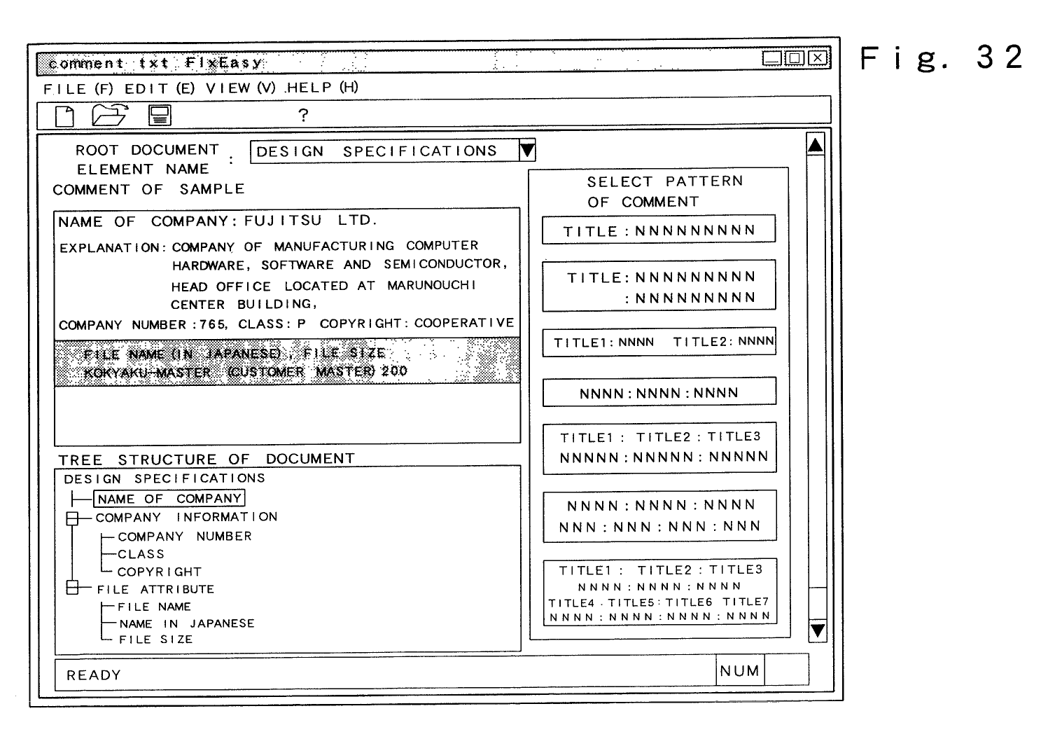

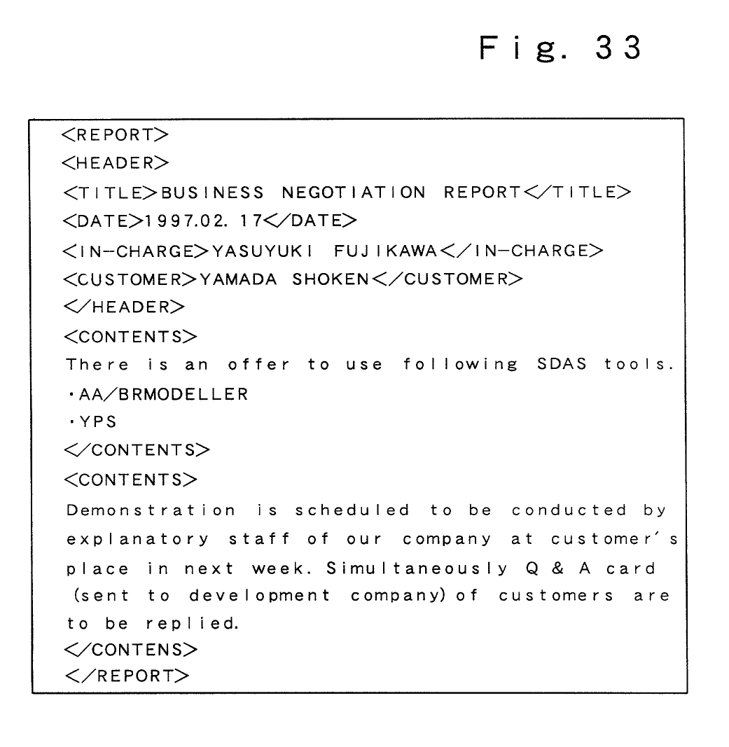

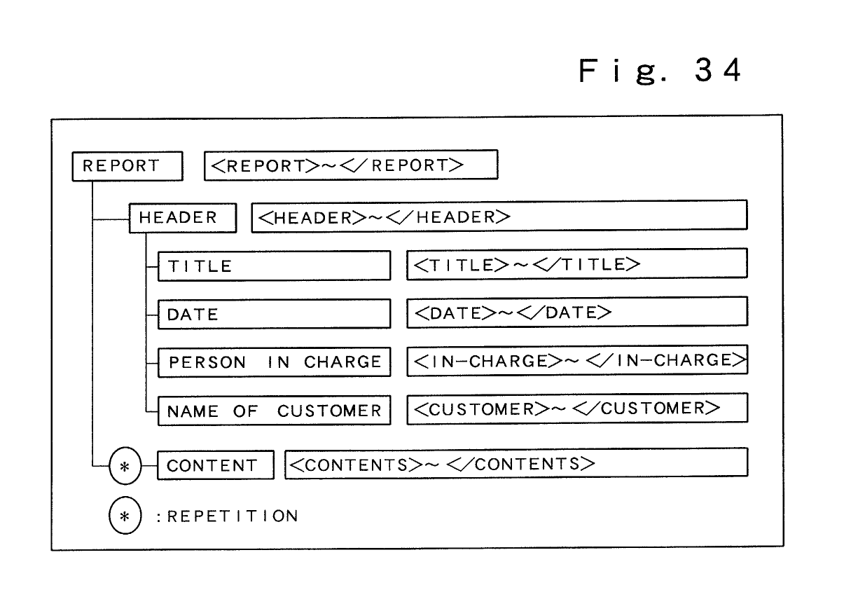

When this “OK” button 707 is clicked, a character string converted based on the character string displayed in each column in the dialog 700′ is substituted into [] in each model information segment S3 in the typical pattern information S shown in FIG. 26. As a result, an element names “file attribute” etc. are displayed as the child node and the grandchild node of the root node “design specifications” in the “tree” list box 73 as shown in FIG. 32.

As discussed above, the content of the extraction condition of each element of the document structure is arbitrarily set, and this extraction condition is applied to the processing target electronic document described in the text format, whereby the region corresponding to each element of the document structure can be extracted. Therefore, the tags corresponding to that element are added to each region extracted, thereby making it feasible to automatically generate the structured document.

We claim:

1. A structural documentation system for converting a processing target electronic document described in a text format into a structured document having a predetermined document structure, said system comprising:
a reading module which reads definition information defining a correlation between elements as basic units configuring the document structure, and defining, for each of the elements, an extraction condition and an identifier thereof;
a retrieving module which refers to the extraction condition per element that is defined by the definition information read by said reading module, and which extracts a region coincident with the per-element extraction condition referred to out of the processing target electronic document; and
a structured document generating module which combines the regions extracted with respect to the respective elements by said retrieving module in accordance with the correlation between the elements that is defined by the definition information, and which generates the structured document by adding to each region an identifier defined by the definition information.

2. A structural documentation system according to claim 1, wherein said structured document generating module adds tags as an identifier in front and rear of each region extracted by said retrieving module.

3. A structural documentation system according to claim 2, wherein said correlation between the elements defined by the definition information takes a hierarchical structure in which one element in a higher-order hierarchy embraces a plurality of elements in a lower-order hierarchy,
said retrieving module extracts regions coincident with respective extraction conditions of the elements in the lower-order hierarchy out of a region extracted with reference to an extraction condition of the element in its higher-order hierarchy, and
said structured document generating module adds tags in front and rear of the region extracted by said retrieving module with respect to the element embracing no element in lower-order hierarchy, and adds the tags for an element embracing elements in lower-order hierarchy in front and rear of a region formed by combining together the regions each extracted by said retrieving module with respect to all the elements in the lower-order hierarchy.

4. A structured documentation system according to claim 3, wherein said correlation between the elements shows a hierarchical structure in which said element in a higher-order hierarchy embraces an element in a lower-order hierarchy that has a repetitive structure,
said retrieving module repeatedly extracts regions coincident with the extraction condition of an element in the lower-order hierarchy having the repetitive structure out of the region extracted with reference to the extraction condition of the element in its higher-order hierarchy till no region coincident with the extraction condition of the element in the lower-order hierarchy can be extracted, and
said structured document generating module adds common tags in front and rear of each of the regions extracted by said retrieving module with respect to the element in the lower-order hierarchy.

5. A structural documentation system according to claim 3, wherein said correlation between the elements shows a hierarchical structure in which one element in a higher-order hierarchy embraces a plurality of sequenced elements in a lower-order hierarchy and
said retrieving module extracts each region coincident with one of said extraction conditions of the elements in the lower-order hierarchy with reference to the extraction condition of the sequenced element in the lower-order hierarchy out of a region from a portion just after an already-extracted region coincident with another extraction condition of the element in lower-order hierarchy within the region extracted with reference to the extraction condition of the element in its higher order hierarchy.

6. A structural documentation system according to claim 1, wherein the extraction condition of any one of the elements defined by the definition information is a description pattern of the whole region to be extracted.

7. A structural documentation system according to claim 1, wherein the extraction condition of any one of the elements defined by the definition information is a description pattern of a start part of the region to be extracted and a description pattern of an end part thereof.

8. A structural documentation system according to claim 6 or 7, wherein the description pattern is expressed by a character string in the region to be extracted.

9. A structural documentation system according to claim 6 or 7, wherein the description pattern is expressed by a regular expression corresponding to the character string in the region to be extracted.

10. A structural documentation system according to claim 1, wherein the extraction condition of any one of the elements defined by the definition information is a syntax element of the region to be extracted.

11. A computer readable medium stored with a program, executed by a computer to perform method comprising step of:
reading a processing target electronic document described in a text format;
reading definition information which defines a correlation between elements as basic units configuring a document structure of a structured document, and which defines, for each of the elements, an extraction condition and an identifier thereof;
referring to the extraction condition per element that is defined by the definition information read in said reading step;
extracting a region coincident with the per-element extraction condition referred to out of the processing target electronic document;
combining the regions extracted with respect to the respective elements in said extracting step in accordance with the correlation between the respective elements that is defined by the definition information; and
generating the structured document by adding to each region an identifier defined by the definition information.
